(19) United States
(12) Patent Application Publication
(10) Pub. No.: US 2024/0378577 A1
(43) Pub. Date: Nov. 14, 2024

(54) MULTI-DIGITAL ASSET SOURCE DIGITAL ASSET-BASED INTERACTION FACILITATION VIA DESTINATION COMPUTING ENTITY-PRESENTED USER INTERFACE

(71) Applicant: Flexa Inc., New York, NY (US)

(72) Inventors: Trevor Filter, New York, NY (US); Zachary Kilgore, Brooklyn, NY (US); Tyler Robert Spalding, New York, NY (US)

(73) Assignee: Flexa Inc., New York, NY (US)

(21) Appl. No.: 18/650,712

(22) Filed: Apr. 30, 2024

Related U.S. Application Data
(60) Provisional application No. 63/464,664, filed on May 8, 2023.

(51) Int. Cl. G06Q 20/12; G06Q 20/40

(52) U.S. Cl. CPC G06Q 20/123; G06Q 20/405; G06Q 2220/10

(57) ABSTRACT

A method includes accessing, by a source computing entity, a destination computing entity-presented user interface to initiate a digital asset-based interaction; providing, by the source computing entity, a set of source inputs to the digital asset-based interaction computing entity, via the destination computing entity-presented user interface; generating, by the digital asset-based interaction computing entity, a digital asset-based interaction request having instructions for pulling the digital assets; locking, by the digital asset-based interaction computing entity, an amount of system digital assets as collateral for the digital assets; and sending, by the digital asset-based interaction computing entity, the destination computing entity a notification of a successful digital asset-based interaction based on the generation of the digital asset-based interaction request.

### CROSS-REFERENCE TO RELATED APPLICATIONS

The present U.S. Utility patent application claims priority pursuant to 35 USC § 119 (e) to U.S. Provisional Application Ser. No. 63/464,664, filed May 8, 2023, entitled “MULTI-DIGITAL ASSET SOURCE DIGITAL ASSET-BASED INTERACTION FACILITATION VIA DIGITAL ASSET-BASED INTERACTION PAGE,” which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates generally to a digital asset-based interaction system and more specifically to using a destination computing entity-presented user interface to facilitate a digital asset-based interaction where a plurality of digital asset source options are possible.

### Description of Related Art

Current payment systems are vulnerable to security breaches, fraud, and identity theft. A typical payment card transaction with a merchant involves several steps (e.g., payment card authorization, clearing, and settlement) and the participation of various entities (e.g., financial institutions, payment card companies, and payment processing networks). Each step and each entity have their own varying security limitations. The steps involved are also inconvenient, time consuming, and expensive. For example, payment card authorization (e.g., credit or debit card authorization) begins with the cardholder presenting the payment card to a merchant for goods or service.

The payment card is issued by a particular financial institution (e.g., a bank) and is associated with a payment card network (e.g., Visa, Mastercard, etc.). The merchant uses a payment card machine, software, or gateway to transmit transaction data to their acquiring bank (or its processor). The acquiring bank routes the transaction data to a payment processing network, and the payment processing network sends the transaction data to the cardholder's issuing bank. The issuing bank validates that the card has not been reported stolen or lost, confirms whether funds/credit is available, and sends a response code back through the payment processing network to the acquiring bank as to whether the transaction is approved.

The transaction data typically includes the payment card number, transaction amount, date, merchant's name, merchant's location, merchant category code, and an encrypted personal identification number (PIN) if entered. A response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The payment processing network debits the issuing bank account and credits the acquiring bank account for the amount of the transaction.

Merchants pay substantial payment card processing fees, and those costs are passed along to consumers in the form of higher prices. Most merchants pay an interchange rate on a total transaction and a flat fee to the payment card company involved (e.g., Visa, Mastercard, etc.). Rates vary based on the payment card company, the payment card type (e.g., credit, debit, business, etc.), processing type (e.g., online payment, swiped, through a mobile device, card not present, etc.), and a Merchant Category Code (MCC) that classifies a merchant's type of business. Further, merchants typically pay a commission and a flat fee to the payment processing network.

Traditional bank account-linked mobile wallet applications allow cardholders to store payment card data on a computing device via a digital wallet for more convenient transactions. For example, some mobile wallet apps use near field communication (NFC) for contactless payments (e.g., exchange of data by holding a device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment.

Digital assets are digitally stored content that comes with a right to use. As a few examples, digital assets include images, audio, videos, documents (e.g., contracts, legal documents, etc.), cryptocurrency, cryptocurrency tokens, stocks, and intellectual property rights. Distributed ledger technology (DLT) is a digital system that provides a consensus of replicated, shared, and synchronized digital data spread across several nodes. Unlike traditional databases, DLTs often lack central authority. The nodes of a DLT implement a verification process such as a consensus method to validate the authenticity of transactions recorded in the ledger.

Distributed ledger technology reduces the risk of fraudulent activity in creating and executing transactions (e.g., such as payments). For example, a blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the network. Once recorded on the blockchain, transactions cannot be altered.

A cryptocurrency is a digital asset that is securely created and transferred via cryptography. Many cryptocurrencies exist on distributed networks based on DLT (e.g., a blockchain). Decentralized networks like Bitcoin use pseudo-anonymous transactions that are open and public (i.e., anyone can join, create, and view transactions). To eliminate fraudulent transactions and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

### BRIEF DESCRIPTION OF THE SEVERAL VIEWS OF THE DRAWING(S)

FIG. 1 is a schematic block diagram of an embodiment of a digital asset-based interaction system;

FIG. 2 is a schematic block diagram of another embodiment of a digital asset-based interaction system;

FIG. 3 is a schematic block diagram of another embodiment of a digital asset-based interaction system;

FIG. 4 is a schematic block diagram of an embodiment of a portion of the digital asset-based interaction system;

FIG. 5 is a schematic block diagram of another embodiment of a digital asset-based interaction system;

FIG. 6 is a schematic block diagram of an embodiment of generating a digital asset-based interaction request;

FIG. 7 is a flowchart of an example of a method of facilitating a digital asset-based interaction via a digital asset-based interaction page;

FIG. 8 is a flowchart of an example of a method of facilitating a digital asset-based interaction via a digital asset-based interaction page;

FIG. 9 is a flowchart of an example of a method of facilitating a digital asset-based interaction via a digital asset-based interaction page;

FIG. 10 is a flowchart of an example of a method of facilitating a digital asset-based interaction via a digital asset-based interaction page;

FIG. 11 is a schematic block diagram of an embodiment of a destination computing entity providing a digital asset-based interaction request link to a source computing entity;

FIG. 12 is a schematic block diagram of an embodiment of a source computing entity providing a set of source inputs to a digital asset-based interaction computing entity via a digital asset-based interaction page;

FIG. 13 is a schematic block diagram of another embodiment of a destination computing entity providing a digital asset-based interaction request link to a source computing entity;

FIG. 14 is a schematic block diagram of another embodiment of a destination computing entity providing a digital asset-based interaction request link to a source computing entity;

FIG. 15 is a schematic block diagram of an embodiment of a source computing entity that includes a destination computing entity application;

FIG. 16 is a flowchart of an example of a method of a digital asset-based interaction using a digital asset pushing request;

FIG. 17 is a schematic block diagram of a source computing entity;

FIG. 18 is a flowchart of an example of a method of a digital asset-based interaction computing entity facilitating a digital asset-based interaction;

FIG. 19 is a flowchart of an example of a method of a real-time digital asset-based interaction process;

FIG. 20 is a flowchart of an example of a method of a nonreal-time digital asset-based interaction process;

FIG. 21 is a flowchart of an example of a method of a real-time digital asset-based interaction process;

FIG. 22 is a flowchart of an example of a method of a real-time digital asset-based interaction process;

FIG. 23 is a flowchart of an example of a method of a real-time digital asset-based interaction process;

FIGS. 24A-24C are flowcharts of an example of a method of a nonreal-time digital asset-based interaction process;

FIG. 25 is a schematic block diagram of an embodiment of a portion of a digital asset-based interaction system;

FIG. 26 is schematic block diagram of an embodiment of a digital asset-based interaction system;

FIG. 27 is a schematic block diagram of an embodiment of a digital asset-based interaction computing entity; and

FIG. 28 is a flowchart of an example of a method of a digital asset-based interaction authorization process.

### DETAILED DESCRIPTION OF THE INVENTION

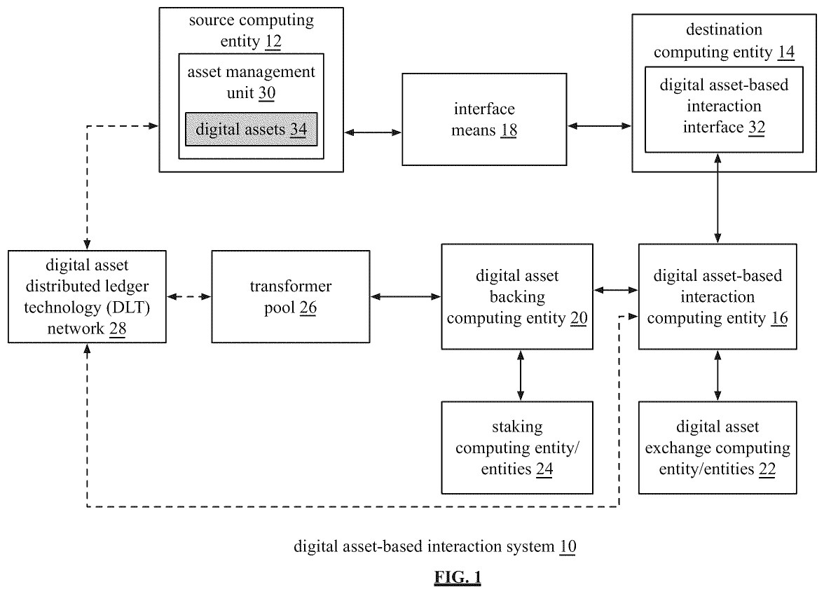

FIG. 1 is schematic block diagram of an embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, at least one transformer pool 26, and at least one digital asset distributed ledger technology (DLT) network 28.

The digital asset-based interaction system 10 facilitates digital asset-based interactions (e.g., a digital asset-based payment) between the source computing entity 12 and the destination computing entity 14. A digital asset-based interaction is any activity (e.g., a loan, a payment, etc.) involving the source computing entity 12 providing digital assets (e.g., digital assets 34) and the destination computing entity 14 accepting desired assets (e.g., fiat currency or a desired digital asset that differs from the digital assets the source computing entity 12 wishes to use in the digital asset-based interaction). Digital assets are digitally stored content that comes with a right to use. As a few examples, digital assets include images, audio, videos, documents (e.g., contracts, legal documents, etc.), cryptocurrency, cryptocurrency tokens, digital fiat currency, stocks, and intellectual property rights.

At the filing of this application, digital assets such as cryptocurrency are not widely accepted by merchants as a form of payment for a variety of reasons. For one, many merchants do not want to hold digital assets. Holding digital assets involves several issues merchants are unfamiliar with and/or unequipped to deal with. These issues include holding private key information, legal compliance, government regulation, timing issues such as waiting for transaction confirmations, etc. Accepting digital assets such as cryptocurrency presents operational security issues and includes a level of technical complexity outside the scope of general merchant capabilities. Additionally, the value of digital assets can be volatile, sometimes fluctuating dramatically in the course of one day. As another reason, merchants are reluctant to invest in expensive point-of-sale upgrades to accommodate digital asset payments directly. As yet another reason, many digital asset payments are public and expose sensitive merchant/customer information.

While some digital wallet applications enable retail blockchain payments, they are dependent on existing payment networks and thus are susceptible to the fraud attacks of the existing payment networks. For example, a digital asset is linked to a payment card (e.g., a credit card, debit card, gift card, etc.), where a digital asset payment is converted and conducted as a payment card transaction and, thus susceptible to the same fraud attacks as the payment card. Further, a billing address and/or other personal customer information may be required for a merchant to verify traditional payment card payments. A merchant may store this information which consumes data storage space and renders additional private customer information vulnerable to theft and fraud. Additionally, the costs of the existing payment network (e.g., payment transaction costs, fees, etc.) are maintained. Adding a digital asset payment option within an existing payment network only increases those costs.

Further, other digital wallet applications that enable retail blockchain payments may require that consumers store their digital assets with the entity that is facilitating the payment such that digital assets can be exchanged and sent to a merchant without the delay of confirming the digital assets sent by a consumer. Thus, the consumer gives up control of their digital assets in order to conduct payments in this manner. Further, when using existing digital asset-based payment systems, a consumer must use the digital wallet application associated with the entity that is facilitating the payment (e.g., the entity that storing digital assets on behalf of a consumer). The consumer therefore lacks the flexibility and freedom of spending from a digital wallet application of their choice.

Even though digital asset-based interactions such as cryptocurrency payments significantly reduce fraudulent activity as compared to traditional payments, fraudulent digital asset-based interactions are possible. For example, malicious users can manipulate a cryptocurrency blockchain to “double spend” (e.g., create one transaction within a block to transfer an amount to a merchant and create another block without that transaction such that the transfer to the merchant does not exist). As another example, malicious or faulty digital wallet software can prevent a digital asset transaction from being authorized and completed correctly.

The digital asset-based interaction system 10 facilitates secure, fraud-less, real-time digital asset-based interactions (e.g., digital asset payments) between source computing entities wishing to use digital assets and destination computing entities wishing to receive desired assets where source computing entities can maintain control of their own digital assets and provide digital assets from a variety of digital asset wallet applications (e.g., asset management units) that are not associated with the digital asset-based interaction system 10 (e.g., associated with the digital asset-based interaction computing entity 16).

As used herein, a computing entity may be one or more computing devices, one or more distributed computing devices, and/or one or more modules executing on one or more computing devices. Within the digital asset-based interaction system 10, the source computing entity 12, the destination computing entity 14, the digital asset-based interaction computing entity 16, the digital asset backing computing entity 20, the one or more digital asset exchange computing entities 22, and the one or more staking computing entities 24 may be one or more computing devices, may be one or more distributed computing devices, and/or one or more modules executing on one or more computing devices.

As used herein, a computing device may be one or more portable computing devices and/or one or more fixed computing devices. The source computing entity 12, the destination computing entity 14, the digital asset-based interaction computing entity 16, the digital asset backing computing entity 20, the one or more digital asset exchange computing entities 22, and the one or more staking computing entities 24 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The source computing entity 12 includes an asset management unit 30 that stores digital assets 34. While only one asset management unit 30 is shown, the source computing entity 12 may include more than one asset management unit. In this example, the asset management unit 30 is storing one type of digital asset (e.g., digital assets 34) for simplicity, but in other embodiments, the source computing entity 12 may store a variety of types and/or amounts of digital assets.

The asset management unit 30 may be a digital wallet application installed on or otherwise usable by the source computing entity 12 that functions to facilitate the storage and management (e.g., buy, sell, trade, custody, etc.) of digital assets 34. The asset management unit 30 is operable to interact with the digital asset distributed ledger technology (DLT) networks (e.g., a blockchain) associated with the digital assets it stores and manages. The asset management unit 30 includes a combination of a public address and a private key.

In this example, the asset management unit 30 is a non-custodial digital wallet application that may be associated with a non-custodial digital asset management computing entity (e.g., a digital asset exchange company) where the asset management unit 30 stores digital assets and a user of the source computing entity 12 manages private keys to the asset management unit 30.

The asset management unit 30 may be a custodial digital wallet application associated with a digital asset management computing entity that may be specially licensed and insured to hold digital assets (e.g., a digital asset holding and management company, a cryptocurrency holding company, a cryptocurrency holding and exchange company, etc.). The digital asset management computing entity (i.e., “the custodian”) of a custodial digital wallet application holds the private key needed to gain access to digital assets.

In this example, the asset management unit 30 is not associated with the digital asset-based interaction computing entity 16, but in other embodiments, the asset management unit 30 may be a custodial or non-custodial digital wallet application associated with the digital asset-based interaction computing entity 16 (e.g., via a source computing entity digital asset-based interaction interface). Alternatively, an asset management unit 30 may be a network enabled smart contract application. A network enabled smart contract application allows a user to upload digital assets to a network enabled smart contract using a private key (e.g., non-custodial) and eliminates double spending issues associated with non-custodial wallets.

The destination computing entity 14 may be associated with a particular merchant that facilitates payments from the source computing entity 12 to the merchant. For example, the destination computing entity 14 may be a fixed POS computing device, a merchant e-commerce website, a merchant mobile application (“app”), etc. The destination computing entity 14 may include payment features tailored to the type of destination computing entity 14 involved in a payment. For example, when the destination computing entity 14 is a fixed POS computing device (e.g., a register), the destination computing entity 14 includes features for an in-person payment interaction (e.g., a scanning device, a touchscreen, a receipt printer, etc.).

As another example, when the destination computing entity 14 is an e-commerce website or merchant mobile application (“app”), the destination computing entity 14 may include a variety of existing payment processing features (e.g., existing hardware and/or software) for processing online payments within existing payment networks (e.g., an Secure Socket Layers (SSL) certificate, e-commerce shopping cart software, order and product management features, customer profile management capabilities, a payment gateway, an e-commerce merchant account with a processing bank to accept credit and debit card payments, etc.).

The destination computing entity 14 includes a digital asset-based interaction interface 32 operable to interface with the digital asset-based interaction computing entity 16. For example, the digital asset-based interaction interface 32 is a digital asset-based interaction computing entity application programming interface (API) integrated into the destination computing entity 14 that allows the destination computing entity 14 to connect to the digital asset-based interaction computing entity 16 for digital asset-based interactions.

The destination computing entity 14 may include an asset management unit that does or does not include the digital asset-based interaction interface 32. When the destination computing entity 14 is associated with a merchant, its asset management unit may be an application that facilitates receiving assets during an interaction such as POS software and/or hardware that may or may not include a digital wallet function depending on the types of assets the destination computing entity 14 wishes to accept and/or the desired method of receiving those assets.

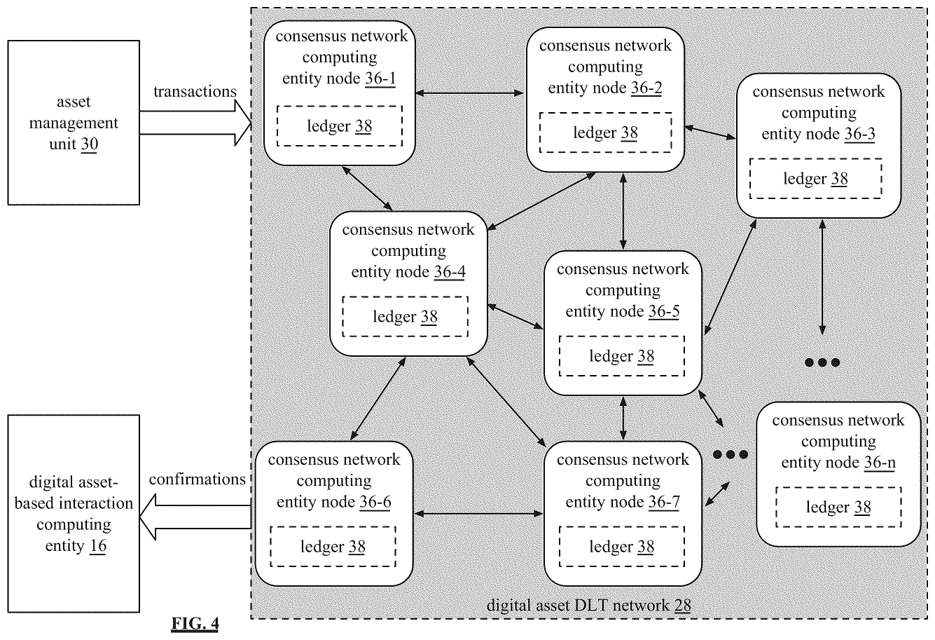

The digital asset DLT network 28 is a digital system associated with the digital assets 34 stored by asset management unit 30. A digital asset DLT network 28 includes a plurality of consensus network computing entity nodes operable to implement a validation procedure to verify the authenticity of transactions recorded on a distributed ledger. For example, the validation procedure is a consensus method. Examples of consensus methods include proof-of-work, proof-of-stake, Practical Byzantine Fault Tolerance (PBFT), and Directed Acyclic Graph (DAG). The plurality of consensus computing entity nodes executes the validation procedure to validate and broadcast transactions to the distributed ledger stored by each consensus network computing entity node of the plurality of consensus network computing entity nodes. The digital asset DLT network 28 and consensus network computing entity nodes will be discussed in more detail with reference to FIG. 4.

A digital asset DLT network 28 may be a multi-layer digital asset DLT network. A multi-layer digital asset DLT network is a digital system associated with a particular digital asset that includes an on-main ledger layer and one or more off-main ledger layers. For example, when an on-main ledger layer has a blockchain data structure, the additional layers to the on-main ledger layer (e.g., a main blockchain) may include one or more nested blockchains, state channels, and sidechains.

The one or more digital asset exchange computing entities 22 are online platforms that allow users to trade digital assets for other forms of digital assets or other assets such as conventional government-issued fiat currency and/or other digital currencies. The one or more digital asset exchange computing entities 22 may be associated with one or more trusted third parties to that may be specially licensed to facilitate exchanges when licensing is required. In an embodiment, the digital asset-based interaction computing entity 16 is a digital asset exchange computing entity where the digital asset exchange computing entity 16 may be specially licensed for exchange when licensing is required.

In another embodiment, the one or more digital asset exchange computing entities 22 may form a decentralized marketplace that does not involve a trusted third party and facilitates peer-to-peer exchanges. In another embodiment, the digital asset-based interaction computing entity 16 and/or the one or more digital asset exchange computing entities 22 may be associated with one or more digital asset holding companies. A digital asset holding company stores sensitive materials and has insurance policies to protect against theft and fraud. A digital asset holding company may be specially licensed for holding digital assets when licensing is required.

The digital asset backing computing entity 20 may be a part of or separate from the digital asset-based interaction computing entity 16. The digital asset backing computing entity 20 manages the storage and use of system digital assets (e.g., system cryptocurrency, system tokens, etc.) for collaterally backing digital asset-based interactions. System digital assets are digital assets that serve as collateral to back digital asset-based interactions of the digital asset-based interaction system 10.

The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency. The digital asset backing computing entity 20 also manages information associated with the one or more staking computing entities 24 such as identifying information of the one or more staking computing entities 24, system digital asset balances and availability, rewards calculations, etc.

The one or more staking computing entities 24 may be one or more user computing devices, one or more merchant computing entities, a digital asset management computing entity associated with an asset management unit, one or more computing entities associated with a corporation and/or business, etc. The one or more staking computing entities 24 (e.g., a user computing device, etc.) are associated with the digital asset backing computing entity 20 via an account (e.g., a stake account). The staking computing entities 24 provide the digital asset backing computing entity 20 with system digital assets and instructions on how to stake the system digital assets. For example, the staking computing entities 24 provide the digital asset backing computing entity 20 instructions to stake (i.e., back) the digital asset DLT network 28 with an amount of system digital assets.

Backing the digital asset DLT network 28 means that a particular consensus network computing entity node of the digital asset DLT network 28 is backed to ensure transactions are written onto the ledger. A consensus network computing entity node of the digital asset DLT network 28 may be associated with the digital asset-based interaction computing entity 16. Backing a particular consensus network computing entity node of the digital asset DLT network 28 is necessary for backing digital asset-based interactions involving digital assets stored in a non-custodial asset management unit not associated with the digital asset-based interaction computing entity 16 because the non-custodial asset management unit is interfacing directly with the digital asset DLT network 28 when initiating digital asset-based interactions. When a digital asset-based interaction involves digital assets stored in a custodial asset management unit, the custodial asset management unit is backed rather than a particular consensus network computing entity node of the digital asset DLT network because the custodian (e.g., a digital asset management computing entity) interacts with the digital asset DLT network on behalf of the source computing entity 12.

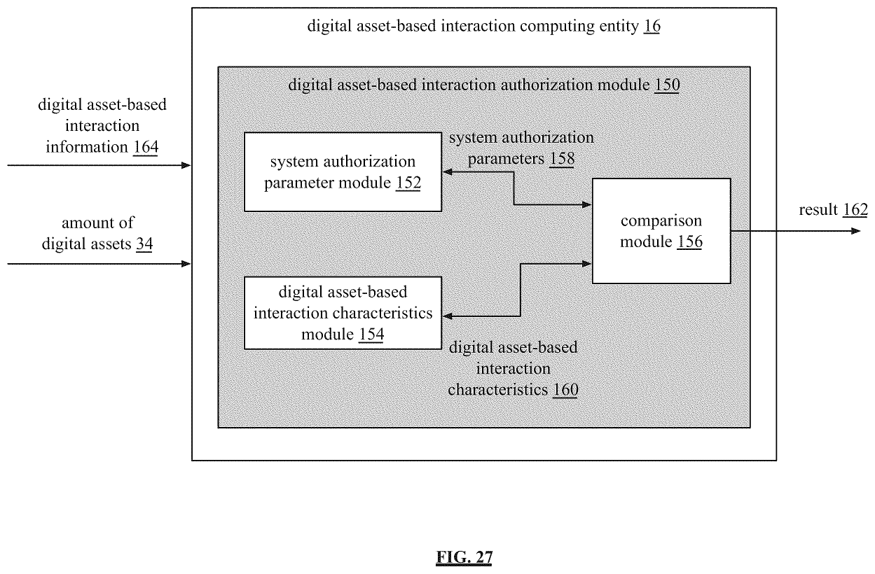

The transformer pool 26 is a smart contract (e.g., an Ethereum smart contract) that stores system digital assets to back digital asset-based interactions involving digital assets 34 stored in a non-custodial asset management unit 30 associated with the digital asset DLT network 28. When the one or more staking computing entities 24 (e.g., a user computing device, etc.) deposit system digital assets with the digital asset backing computing entity 20, the digital asset backing computing entity 20 keeps track of the deposits within the staking computing entity's account and is further operable to deposit an amount of the system digital assets into a particular transformer pool in accordance with system digital asset instructions (e.g., what digital asset DLT networks a staking computing entity wishes to back and for how much). The one or more staking computing entities 24, the digital asset backing computing entity 20, and the transformer pool 26 will be discussed in more detail with reference to FIG. 26.

Because the transformer pool 26 stores system digital assets to back digital asset-based interactions involving digital assets 34, the source computing entity 12 may use the digital assets 34 for digital asset-based interactions within the digital asset-based interaction system 10 regardless of asset management unit 30 used to store the digital assets 34. Thus, the source computing entity 12 has the freedom and flexibility to use the asset management unit 30 of its choosing while still benefiting from the secure and fast digital asset-based interaction processing of the digital asset-based interaction system 10.

The source computing entity 12 and the destination computing entity 14 interact via one or more interface means 18. For example, the source computing entity 12 and the destination computing entity 14 interact to initiate a digital asset-based interaction (may also be referred to herein as “interaction”). Initiation of a digital asset-based interaction will be discussed in further detail with reference to one or more of the subsequent Figures.

The interface means 18 includes one or more of: a direct link and a network connection. The direct link includes one or more of: a scanning device (e.g., video, camera, infrared (IR), barcode scanner, etc.), radio frequency (RF), and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

As an example, the source computing entity 12 is a smart phone, the destination computing entity 14 is a fixed merchant POS computing device (e.g., a POS register) and the interface means 18 is the fixed merchant POS computing device's scanning device (e.g., camera, barcode scanner, etc.). As another example, the source computing entity 12 is a smart phone, the destination computing entity 14 is a fixed merchant POS device (e.g., a POS register) and the interface means 18 is the smart phone's scanning device (e.g., a front or back camera).

As another example, the source computing entity 12 is a smart phone, the destination computing entity 14 is an online POS connection device (e.g., an e-commerce website or e-commerce mobile app) and the interface means 18 is a network connection. For example, a smart phone uses an internet browser application (via cellular or wireless internet connection) to access a merchant's e-commerce website. As another example, a smart phone uses a network connection to connect to an installed merchant e-commerce mobile app.

As yet another example, a combination of interface means 18 is possible. For example, the source computing entity 12 is a smart phone and the destination computing entity 14 is an online POS connection device (e.g., an e-commerce website). The e-commerce website is accessed via a network connection interface means 18 on a computing device associated with the user of the source computing entity 12 (e.g., a laptop or desktop computer). The computing device displays information for use by the source computing entity's scanning device (e.g., front or back camera).

The digital asset-based interaction computing entity 16 is operable to facilitate digital asset-based interactions between the source computing entity 12 and the destination computing entities 14 by performing a real-time digital asset-based interaction process and a nonreal-time digital asset-based interaction process to reconcile the real-time digital asset-based interaction process with the digital asset backing computing entity 20. The digital asset-based interaction computing entity 16 is also operable to authorize digital asset-based interactions in accordance with system authorization parameters. Authorizing digital asset-based interactions will be discussed in more detail with reference to FIGS. 26-28.

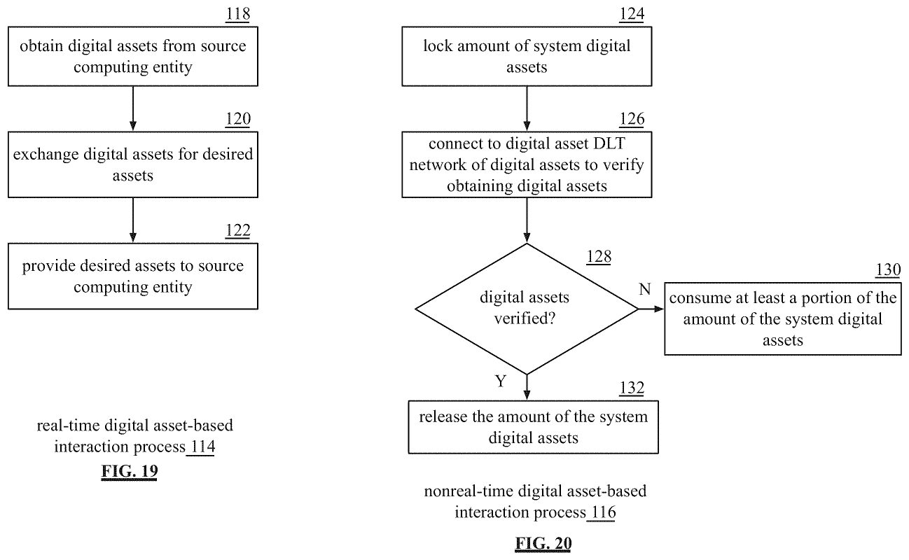

To perform the real-time digital asset-based interaction process, the digital asset-based interaction computing entity 16 is operable to connect to the one or more digital asset exchange computing entities 34 to convert digital assets to one or more desired assets (e.g., fiat currency, another digital asset, whatever asset format is desired by the destination computing entity 14) and send the desired assets to the destination computing entity 14. The real-time digital asset-based interaction process will be discussed in greater detail with reference to FIGS. 19 and 21-23.

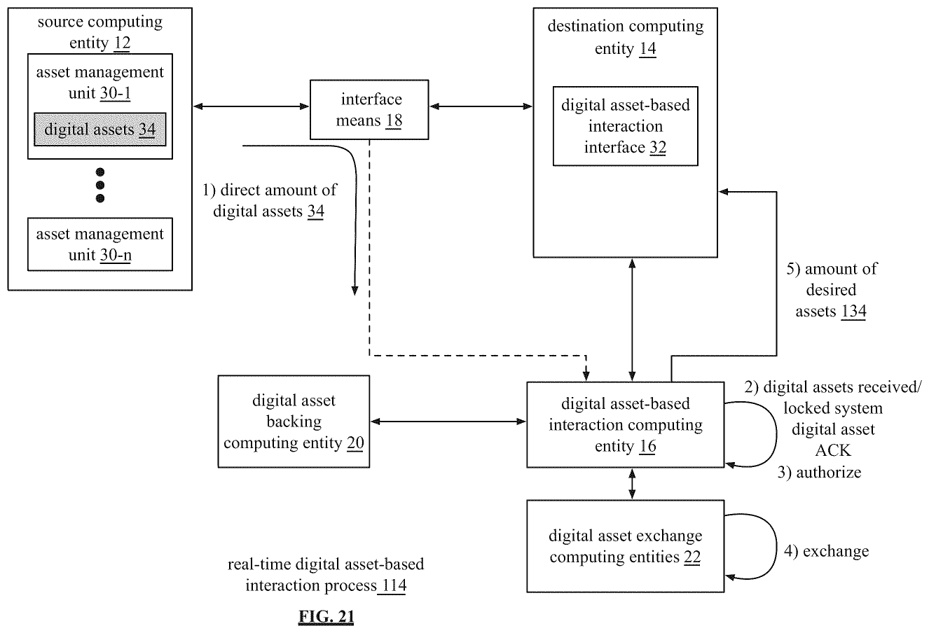

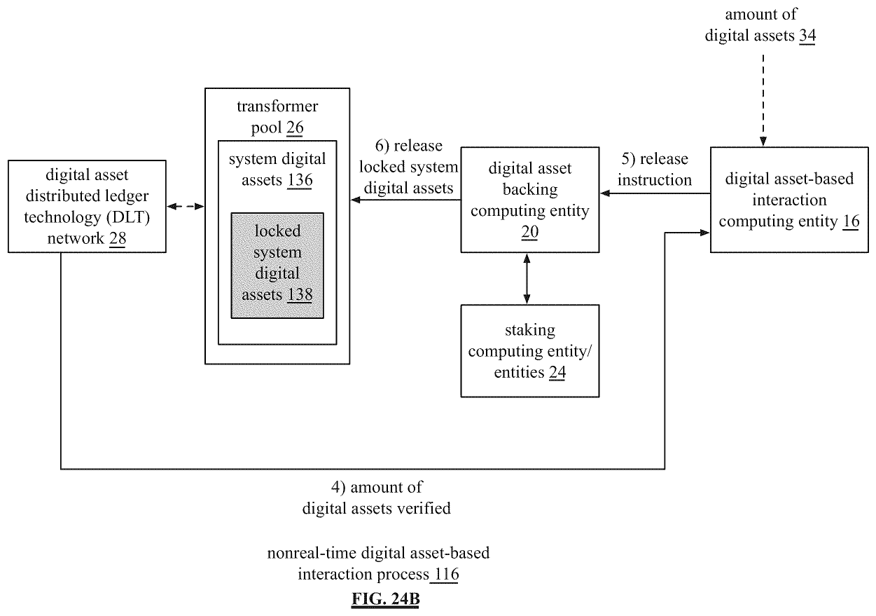

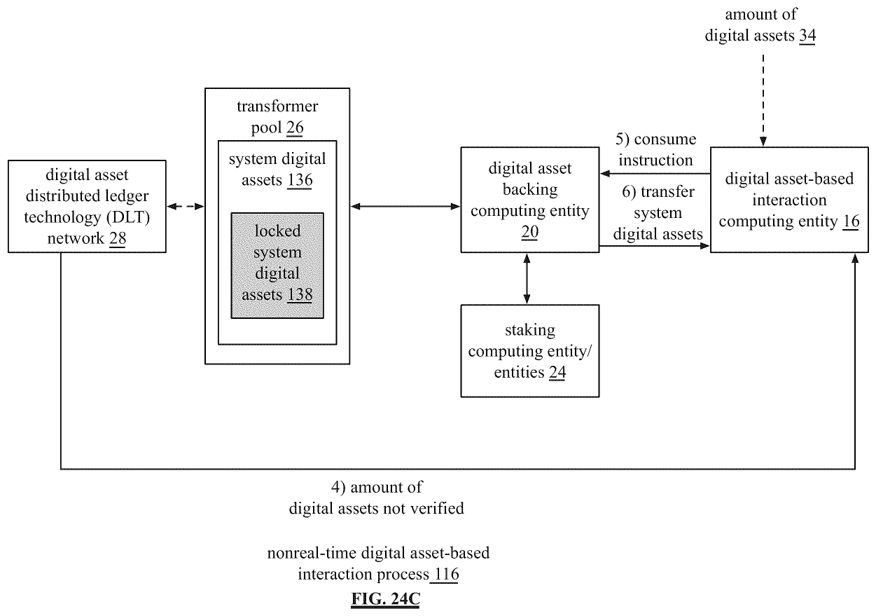

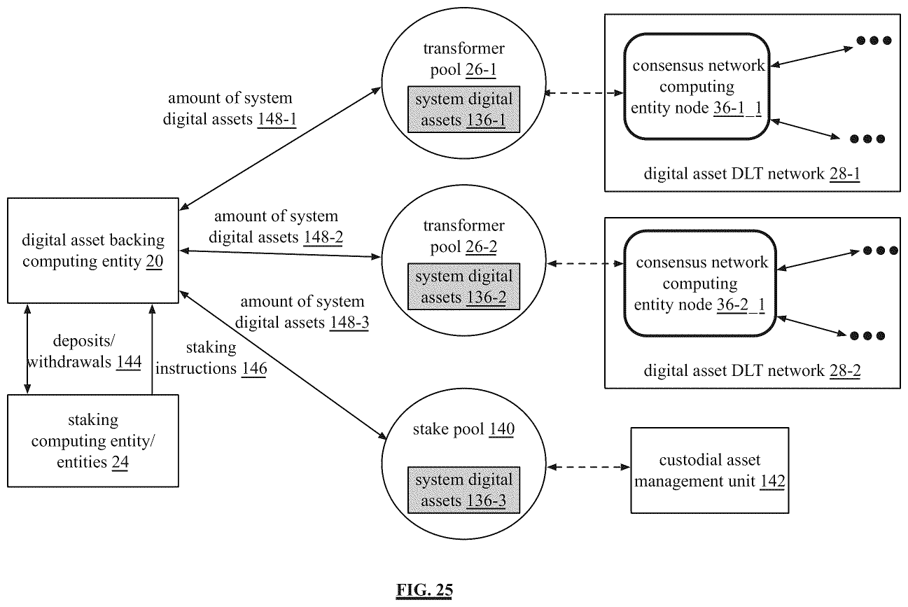

To perform the nonreal-time digital asset-based interaction process, the digital asset-based interaction computing entity 16 is operable to communicate with the digital asset backing computing entity 20 to back digital asset-based interactions such that they can be authorized and/or completed successfully in real-time and connect to the digital asset distributed ledger technology (DLT) network 28 associated with the digital assets to verify receipt of digital assets. The nonreal-time digital asset-based interaction process will be discussed in greater detail with reference to FIGS. 20 and 24A-24C.

The digital asset-based interaction computing entity 16 may be associated with a stored value account (SVA) device where the SVA device is associated with the destination computing entity 14 (e.g., a destination computing entity 14 has an SVA account with the SVA device) such that an SVA is generated for payment. In another embodiment, the digital asset-based interaction computing entity 16 is operable to generate stored value accounts (SVAs). Generation of SVAs for transactions is described in co-pending patent application Ser. No. 16/376,911, entitled, “SECURE AND TRUSTED DATA COMMUNICATION SYSTEM,” filed Apr. 5, 2019.

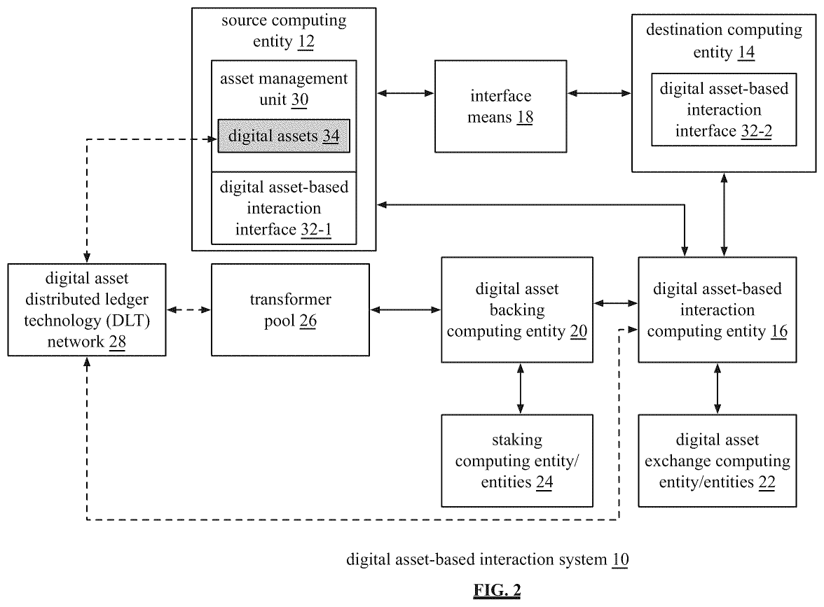

FIG. 2 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a transformer pool 26, and a digital asset distributed ledger technology (DLT) network 28.

The digital asset-based interaction system 10 of FIG. 2 operates similarly to the digital asset-based interaction system 10 of FIG. 1 except that the asset management unit 30 of the source computing entity 12 includes a digital asset-based interaction interface 32-1 that is associated with the digital asset-based interaction computing entity 16. Even though the source computing entity 12 is not obligated to use an asset management unit 30 associated with the digital asset-based interaction computing entity 16 to conduct digital asset-based interactions with the digital assets 34, the source computing entity 12 could choose to use the asset management unit 30 associated with the digital asset-based interaction computing entity 16 (e.g., with the digital asset-based interaction interface 32-1) for a plurality of other features.

For example, by using the asset management unit 30 with the digital asset-based interaction interface 32-1, the source computing entity 12 is operable to obtain scannable codes from the digital asset-based interaction computing entity 16 to initiate digital asset-based interactions with the destination computing entity 14.

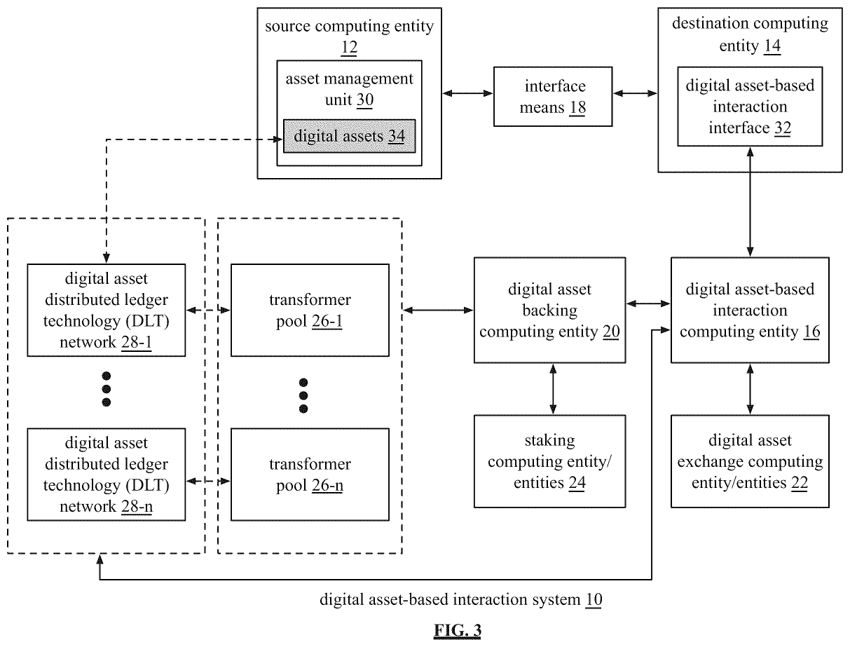

FIG. 3 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a plurality of transformer pools 26-1 through 26-n, and a plurality of digital asset distributed ledger technology (DLT) networks 28-1 through 28-n.

The digital asset-based interaction system 10 of FIG. 3 operates similarly to the digital asset-based interaction system of FIG. 1 except that the digital asset-based interaction system 10 of FIG. 3 includes a plurality of transformer pools 26-1 through 26-n and a plurality of digital asset DLT networks 28-1 through 28-n. For example, a first digital asset DLT network 28-1 is associated with the digital assets 34 and a first transformer pool 26-1 stores system digital assets to back digital asset-based interactions associated with the digital assets 34. As another example, a second digital asset DLT network 28-2 is associated with second digital assets and a second transformer pool 26-2 stores system digital assets to back digital asset-based interactions associated with the second digital assets. As another example, a third digital asset DLT network 28-3 is associated with third digital assets and a third transformer pool 26-3 stores system digital assets to back digital asset-based interactions associated with the third digital assets.

FIG. 4 is a schematic block diagram of an embodiment of a portion of the digital asset-based interaction system that includes an asset management unit 30 (e.g., of the source computing entity), a digital asset-based interaction computing entity 16, and a digital asset distributed ledger technology (DLT) network 28.

The digital asset DLT network 28 includes a plurality of consensus network computing entity nodes 36-1 through 36-n (also referred to herein as nodes) that each store a distributed and replicated ledger 38 and use validation procedures (e.g., consensus methods) to ensure replication across the plurality of consensus network computing entity nodes 36-1 through 36-n is undertaken. Distributed ledgers 38 may be permissioned, permissionless, or hybrid. Consensus methods include proof of work, proof of stake, delegated proof of stake, Byzantine Fault Tolerance, voting systems, etc.

When a user such as the asset management unit 30 submits a new transaction, it is received by a consensus network computing entity node of the plurality of consensus network computing entity nodes 36-1 through 36-n and the consensus network entity node broadcasts the transaction to the rest of the network. When a new transaction on the ledger 38 occurs, each of the consensus network computing entity nodes 36-1 through 36-n construct the new transaction and vote by a consensus method on which copy of the ledger 28 is correct. Once consensus is determined, all consensus network computing entity nodes 36-1 through 36-n update the ledger 38 with the correct copy. Blockchain is a form of digital asset DLT network that uses cryptographic and algorithmic approaches to create and verify a continuously expanding, append-only data structure that gradually turns into a chain of transaction blocks that serve the role of the ledger 38.

In the Bitcoin blockchain, nodes validate transactions and specialized nodes known as miners (or a collective of miners) pick up the transactions and compete to confirm pending transactions. Going from pending to confirmed means that the transaction has been added to the ledger (blockchain). Bitcoin miners batch pending transactions into what are known as blocks. The confirmed block is propagated across the entire network back to all nodes. Once validated, the nodes add the block to the previous block thus creating a blockchain. Some blockchain networks do not require mining such as blockchains that use proof of stake consensus methods where participants must have a stake in the blockchain to select, verify, and validate transactions.

Non-blockchain forms of digital asset DLT networks store transactions in data architectures that differ from blockchains. For example, a hashgraph data structure stores all transactions in a parallel structure. Hashgraphs do not use miners to validate transactions and instead use a “gossip about gossip” consensus method where individual nodes on the network “gossip” about transactions to create directed acyclic graphs that time-sequence transactions without bundling them into blocks.

In this example, the asset management unit 30 is adding one or more transactions (e.g., a digital asset-based interaction may include one or more transactions) to the digital asset DLT network 28. For example, a digital asset-based interaction involving a digital asset associated with the digital asset DLT network 28 is added as a transaction on the ledger 38. To add the transaction on the ledger 38, a particular consensus network computing entity node receives the transaction and broadcasts it to the other consensus network computing entity nodes on the digital asset DLT network 28. The on-ledger transaction includes information related to the asset management unit 30 sending an amount of the digital assets to the digital asset-based interaction computing entity 16. To ensure that the transaction is added to the ledger, the consensus network computing entity node receiving the transaction is backed with system digital assets (e.g., the digital asset DLT network 28 is backed).

The digital asset-based interaction computing entity 16 communicates with the digital asset DLT network 28 to obtain a desired amount of confirmations regarding the digital asset-based interaction transaction added via the asset management unit 30. Based on the type of digital asset DLT network 28 and the validation procedures used by the digital asset DLT network 28, the desired amount of confirmations may take minutes to hours of time to obtain.

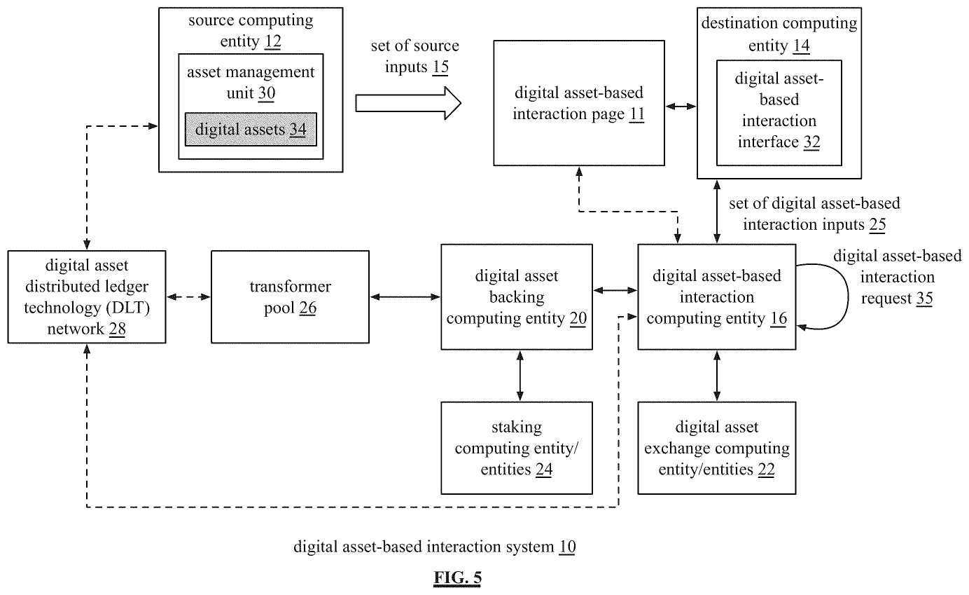

FIG. 5 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a transformer pool 26, and a digital asset distributed ledger technology (DLT) network 28.

The digital asset-based interaction system 10 of FIG. 5 operates similarly to the digital asset-based interaction system 10 of FIG. 1 except that a digital asset-based interaction page 11 associated with the destination computing entity 14 is shown. The digital asset-based interaction page 11 is also referred to herein as a destination computing entity-presented user interface.

The digital asset-based interaction page 11 is a user interface accessible by the source computing entity 12 that allows the source computing entity 12 to submit information to the digital asset-based interaction computing entity 16 for an interaction with a destination computing entity 14 (e.g., a merchant). The digital asset-based interaction page 11 is presented by the destination computing entity 14 and may be a digital asset-based interaction computing entity-hosted page (i.e., a destination computing entity-presented digital asset-based interaction interface hosted by the digital asset-based interaction computing entity on or associated with the destination computing entity), a digital asset-based interaction computing entity associated API integration (e.g., part of the digital asset-based interaction interface 32), and/or a part of a software development kit (SDK) of a mobile application. The source computing entity 12 may be presented with a digital asset-based interaction request link (e.g., a quick response (QR) code, scannable code, and/or a uniform resource identifier (URL)) to connect to a digital asset-based interaction page 11. In another embodiment, a deep link allows for the source computing entity 12 to connect to a digital asset-based interaction page 11 (e.g., via a mobile application). Accessing the digital asset-based interaction page 11 will be discussed in more detail with reference to one or more of the following Figures.

The source computing entity 12 accesses the digital asset-based interaction page 11 to initiate a digital asset-based interaction with the destination computing entity 14. The digital asset-based interaction page 11 prompts the source computing entity 12 to enter in a set of source inputs 15 to the digital asset-based interaction page 11 which are obtained by the digital asset-based interaction computing entity 16. The set of source inputs 15 may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The digital asset-based interaction computing entity 16 generates a digital asset-based interaction request 35 based on a set of digital asset-based interaction inputs 25. The set of digital asset-based interaction inputs 25 includes at least some of the set of source inputs and optionally destination computing entity information when necessary (e.g., an amount of the digital asset-based interaction, etc.). The digital asset-based interaction request 35 is a set of digital asset-based interaction instructions for accessing the digital asset source (e.g., an address, an amount, etc.). For example, when the set of source inputs identifies Bitcoin as the type of digital asset and Coinbase as the digital asset source, the digital asset-based interaction computing entity 16 generates a digital asset-based interaction request 35 with instructions on pulling the required amount of Bitcoin from the source computing entity's Coinbase address.

When the digital asset-based interaction request 35 is generated, the digital asset-based interaction computing entity 16 notifies the destination computing entity 14 that the digital asset-based interaction is successful such that a real-time interaction between the source computing entity 12 and the destination computing entity 14 can be finalized and then facilitates the completion of the digital asset-based interaction.

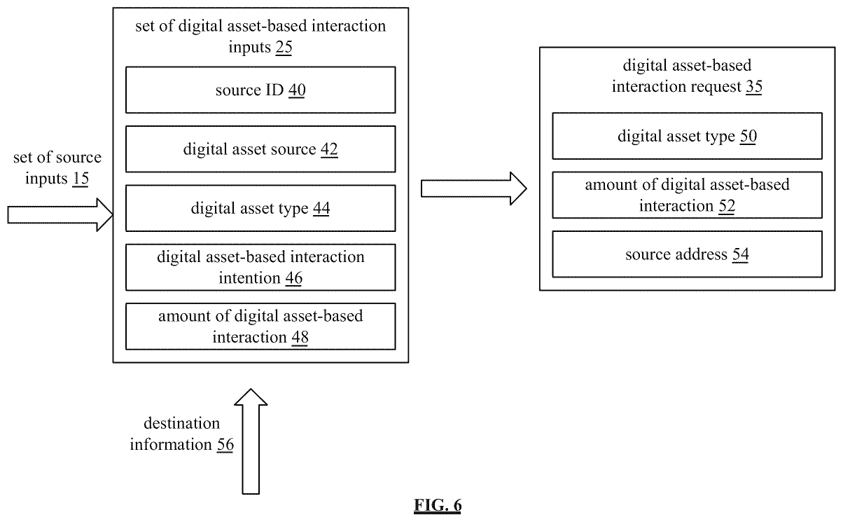

FIG. 6 is a schematic block diagram of an embodiment of generating a digital asset-based interaction request 35. FIG. 6 includes a set of digital asset-based interaction inputs 25. The set of digital asset-based interaction inputs 25 are based on a set of source inputs 15 from the source computing entity 12 and/or destination information 56 from the destination computing entity 16. The set of source inputs 15 may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The destination information 56 may include a destination computing entity 14 identifier (e.g., a merchant ID), payment receival preferences, discount information, the desired assets to be received, the amount of the digital asset-based interaction, and any other destination computing entity or digital asset-based interaction information.

In this example, the digital asset-based interaction inputs 25 include a source identifier (ID) 40 (e.g., a username, an email address, etc.), a digital asset source (e.g., a desired network, a desired wallet application, etc.) 42, a digital asset type 44, a digital asset-based interaction intention 46 (e.g., a confirmation received from the source computing entity), and an amount of the digital asset-based interaction 48.

The digital asset-based interaction computing entity 16 generates a digital asset-based interaction request 35 based on a set of digital asset-based interaction inputs 25. The digital asset-based interaction request 35 is a set of digital asset-based interaction instructions for a particular network. As shown here, the digital asset-based interaction request 35 includes a digital asset type 50, the amount of the digital asset-based interaction 52, and the source address 54 for the digital assets.

For example, when the set of source inputs identifies Bitcoin as the digital asset type 50 and Coinbase as the digital asset source, the digital asset-based interaction computing entity 16 generates a digital asset-based interaction request 35 with instructions on pulling the required amount of Bitcoin from the source computing entity's Coinbase address.

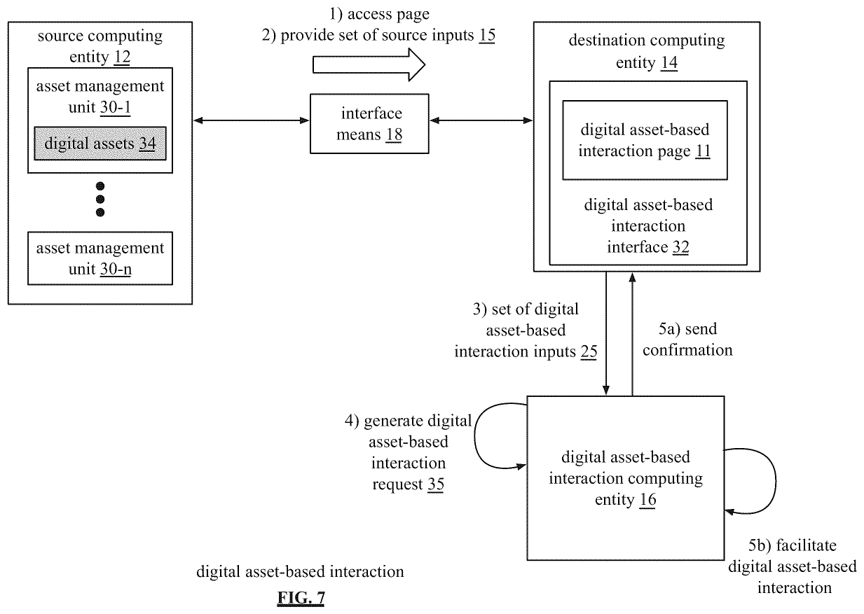

FIG. 7 is a flowchart of an example of a method of facilitating a digital asset-based interaction via a digital asset-based interaction page 11. FIG. 7 depicts a portion of a digital entity 14, an interface means 18, and a digital asset-based interaction computing entity 16.

The source computing entity 12 includes a plurality of asset management units 30-1 through 30-n. An asset management unit 30-1 stores digital assets 34. In this example, the asset management unit 30-1 is not associated with the digital asset-based interaction computing entity 16. The method begins with step 1 where a source computing entity 12 accesses a digital asset-based interaction page 11 to initiate a digital asset-based interaction with a destination computing entity 14. The digital asset-based interaction involves the source computing entity 12 providing digital assets 34 and the destination computing entity 14 accepting desired assets. In this example, the source computing entity 12 connects to the destination computing entity 14 via an interface means 18 to access the digital asset-based interaction page 11. For example, the digital asset-based interaction page 11 is integrated in the API of the destination computing entity 11 and is an aspect of the digital asset-based interaction interface 32 that connects to the digital asset-based interaction computing entity 16.

The method continues with step 2 where the source computing entity 12 inputs a set of source inputs 15 via the digital asset-based interaction page 11. The set of source inputs may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The method continues with step 3 where the digital asset-based interaction computing entity obtains a set of digital asset-based interaction inputs 25 from the digital asset-based interaction page 11. The set of digital asset-based interaction inputs 25 includes at least some of the set of source inputs and optionally destination computing entity information when necessary (e.g., an amount of the digital asset-based interaction, desired assets, etc.).

The method continues with step 3 where the digital asset-based interaction computing entity 16 generates a digital asset-based interaction request 35 based on the set of digital asset-based interaction inputs 25. The digital asset-based interaction request 35 is a set of digital asset-based interaction instructions for a particular network. For example, when the set of source inputs identifies Bitcoin as the type of digital asset and Coinbase as the digital asset source (e.g., a particular asset management unit), the digital asset-based interaction computing entity 16 generates a digital asset-based interaction request 35 with instructions on pulling the required amount of Bitcoin from the source computing entity's Coinbase address.

The method continues with steps 5a and 5b which may occur concurrently or slightly before or after one another (e.g., step 5b occurs slightly before step 5a). At step 5a, the digital asset-based interaction computing entity 16 sends the destination computing entity 14 a confirmation that the digital asset-based interaction is successful. At step 5b, the digital asset-based interaction computing entity 16 facilitates the digital asset-based interaction based on the digital asset-based interaction request using a real-time digital asset-based interaction process and a nonreal-time digital asset-based interaction process. The real-time digital asset-based interaction process and a nonreal-time digital asset-based interaction process will be described in greater detail with reference to one or more of the subsequent Figures.

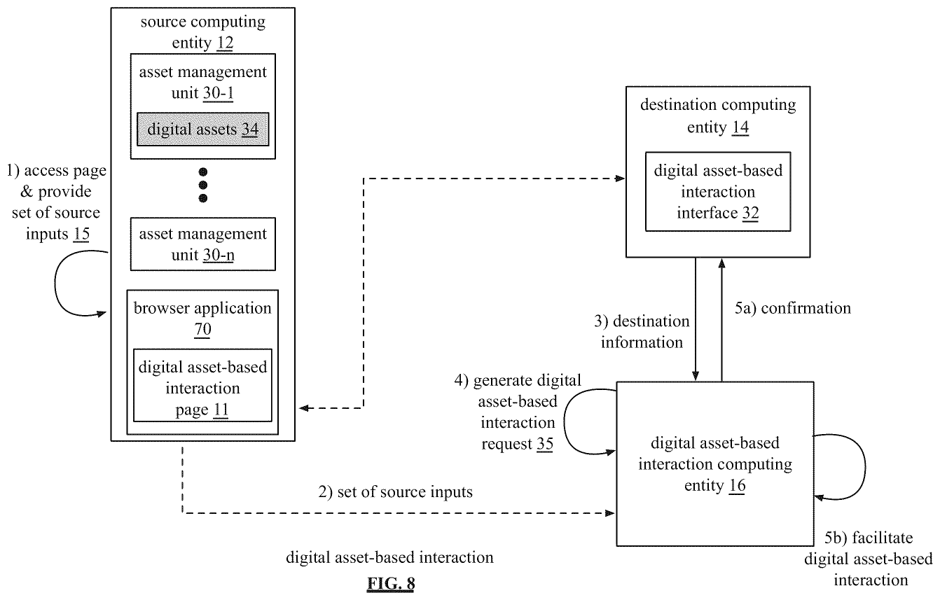

FIG. 8 is a flowchart of an example of a method of facilitating a digital asset-based interaction via a digital asset-based interaction page 11. FIG. 8 depicts a portion of a digital asset-based interaction system that includes a source computing entity 12, a destination computing entity 14, an interface means 18, and a digital asset-based interaction computing entity 16.

The source computing entity 12 includes a plurality of asset management units 30-1 through 30-n and a browser application 70. An asset management unit 30-1 stores digital assets 34. In this example, the asset management unit 30-1 is not associated with the digital asset-based interaction computing entity 16.

The method begins with step 1 where a source computing entity 12 accesses a digital asset-based interaction page 11 to initiate a digital asset-based interaction with a destination computing entity 14. The digital asset-based interaction involves the source computing entity 12 providing digital assets 34 and the destination computing entity 14 accepting desired assets. In this example, the source computing entity 12 includes a browser application 70 that provides access to the digital asset-based interaction page 11 via a destination computing entity 14 associated website. The digital asset-based interaction page 11 is operable to interface with the digital asset-based interaction computing entity 16.

The method continues with step 2 where the source computing entity 12 inputs a set of source inputs 15 via the digital asset-based interaction page 11 which are sent to the digital asset-based interaction computing entity 16. The set of source inputs may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The method optionally continues with step 3 where the digital asset-based interaction computing entity obtains destination information (e.g., an amount of the digital asset-based interaction, type of desired assets, a merchant ID, a merchant terminal ID, etc.) from the destination computing entity 14 via the digital asset-based interaction interface 32.

The method continues with step 4 where the digital asset-based interaction computing entity 16 generates a digital asset-based interaction request 35 based on the set of source inputs and the destination information. The digital asset-based interaction request 35 is a set of digital asset-based interaction instructions for a particular network. For example, when the set of source inputs identifies Bitcoin as the type of digital asset and Coinbase as the digital asset source (e.g., a particular asset management unit), the digital asset-based interaction computing entity 16 generates a digital asset-based interaction request 35 with instructions on pulling the required amount of Bitcoin from the source computing entity's Coinbase address.

The method continues with steps 5a and 5b which may occur concurrently or slightly before or after one another (e.g., step 5b occurs slightly before step 5a). At step 5a, the digital asset-based interaction computing entity 16 sends the destination computing entity 14 a confirmation that the digital asset-based interaction is successful. At step 5b, the digital asset-based interaction computing entity 16 facilitates the digital asset-based interaction based on the digital asset-based interaction request using a real-time digital asset-based interaction process and a nonreal-time digital asset-based interaction process. The real-time digital asset-based interaction process and a nonreal-time digital asset-based interaction process will be described in greater detail with reference to one or more of the subsequent Figures.

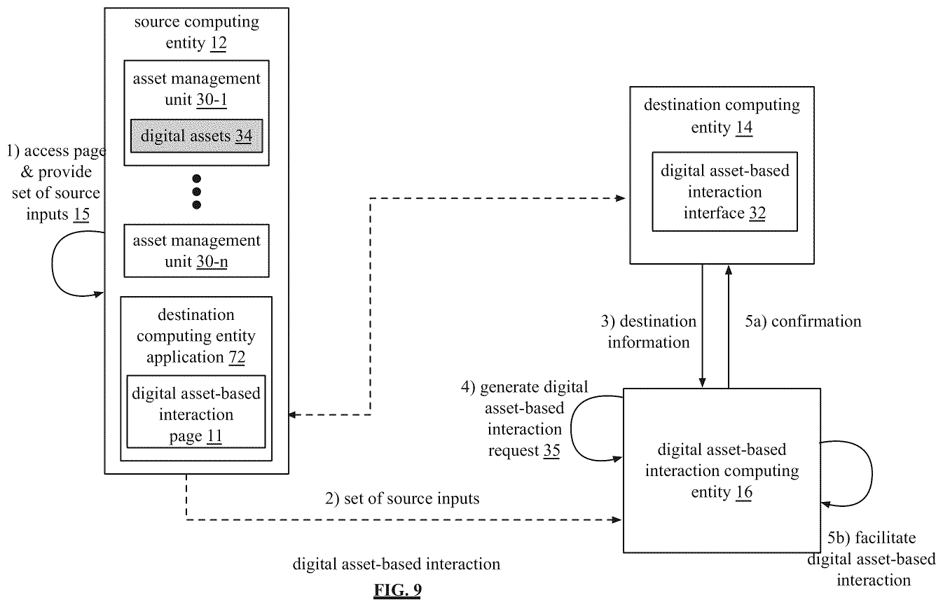

FIG. 9 is a flowchart of an example of a method of facilitating a digital asset-based interaction via a digital asset-based interaction page 11. FIG. 9 depicts a portion of a digital entity 14, an interface means 18, and a digital asset-based interaction computing entity 16.

The source computing entity 12 includes a plurality of asset management units 30-1 through 30-n and a destination computing entity application 72. An asset management unit 30-1 stores digital assets 34. In this example, the asset management unit 30-1 is not associated with the digital asset-based interaction computing entity 16. The method begins with step 1 where a source computing entity 12 accesses a digital asset-based interaction page 11 to initiate a digital asset-based interaction with a destination computing entity 14. The digital asset-based interaction involves the source computing entity 12 providing digital assets 34 and the destination computing entity 14 accepting desired assets. In this example, the source computing entity 12 includes a destination computing entity application 72 associated with the destination computing entity 14 that provides access to the digital asset-based interaction page 11. The digital asset-based interaction page 11 is operable to interface with the digital asset-based interaction computing entity 16.

The method continues with step 2 where the source computing entity 12 inputs a set of source inputs 15 via the digital asset-based interaction page 11 which are sent to the digital asset-based interaction computing entity 16. The set of source inputs may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The method optionally continues with step 3 where the digital asset-based interaction computing entity obtains destination information (e.g., an amount of the digital asset-based interaction, type of desired assets, etc.) from the destination computing entity 14 via the digital asset-based interaction interface 32.

The method continues with step 4 where the digital asset-based interaction computing entity 16 generates a digital asset-based interaction request 35 based on the set of source inputs and the destination information. The digital asset-based interaction request 35 is a set of digital asset-based interaction instructions for a particular network. For example, when the set of source inputs identifies Bitcoin as the type of digital asset and Coinbase as the digital asset source (e.g., a particular asset management unit), the digital asset-based interaction computing entity 16 generates a digital asset-based interaction request 35 with instructions on pulling the required amount of Bitcoin from the source computing entity's Coinbase address.

The method continues with steps 5a and 5b which may occur concurrently or slightly before or after one another (e.g., step 5b occurs slightly before step 5a). At step 5a, the digital asset-based interaction computing entity 16 sends the destination computing entity 14 a confirmation that the digital asset-based interaction is successful. At step 5b, the digital asset-based interaction computing entity 16 facilitates the digital asset-based interaction based on the digital asset-based interaction request using a real-time digital asset-based interaction process and a nonreal-time digital asset-based interaction process. The real-time digital asset-based interaction process and a nonreal-time digital asset-based interaction process will be described in greater detail with reference to one or more of the subsequent Figures.

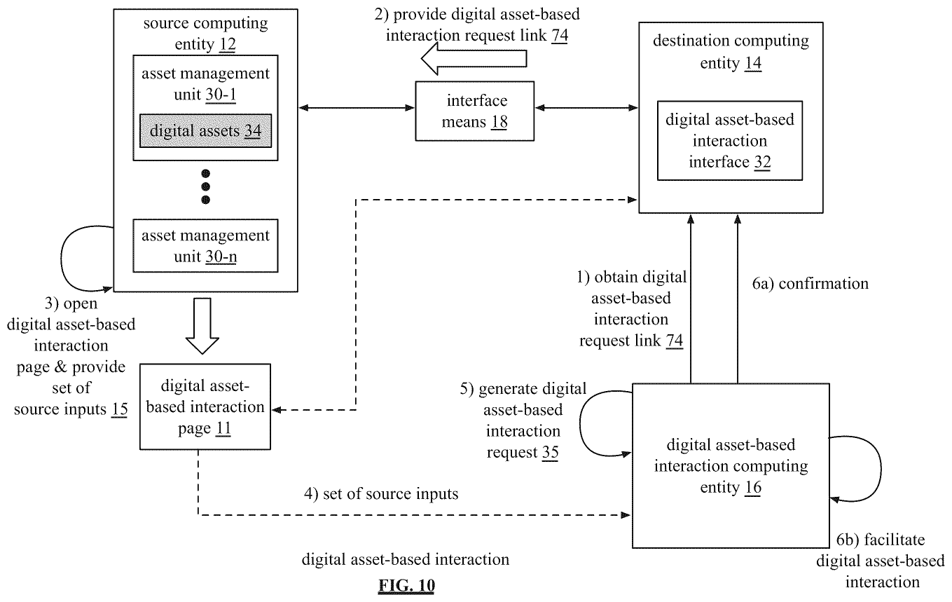

FIG. 10 is a flowchart of an example of a method of facilitating a digital asset-based interaction via a digital asset-based interaction page 11. FIG. 10 depicts a portion of a digital asset-based interaction system that includes a source computing entity 12, a destination computing entity 14, an interface means 18, and a digital asset-based interaction computing entity 16.

The source computing entity 12 includes a plurality of asset management units 30-1 through 30-n. An asset management unit 30-1 stores digital assets 34. In this example, the asset management unit 30-1 is not associated with the digital asset-based interaction computing entity 16. The method begins with step 1 where the destination computing entity 14 obtains a digital asset-based interaction request link 74 from the digital asset-based interaction computing entity 16 for use in a digital asset-based interaction. The digital asset-based interaction request link 74 may be a quick response (QR) code, another type of scannable code, a uniform resource locator (URL) link, a button (e.g., a hyper text markup language (HTML) button, or any type of mechanism for directing the source computing entity to a digital asset-based interaction page 11. The digital asset-based interaction request link 74 may be a repeatable link that can be repeatedly used for separate sources but related destination digital asset-based interactions (e.g., a donation link to a particular cause). For example, a repeatable link could allow a route to a new instance of the digital asset-based interaction page 11 each time it is accessed.

The destination computing entity 14 may provide destination computing entity information and/or digital asset-based interaction information to the digital asset-based interaction computing entity 16 such that the digital asset-based interaction computing entity 16 provides a link specific to the digital asset-based interaction. In another embodiment, the destination computing entity 14 may be operable to generate the digital asset-based interaction request link 74. The method continues with step 2 where the destination computing entity 14 provides the digital asset-based interaction request link 74 to the source computing entity 12 via an interface means 18.

The method continues with step 3 where the source computing entity 12 accesses a digital asset-based interaction page 11 through the digital asset-based interaction request link 74 (e.g., a website via a browser application or a destination computing entity mobile application opens to a digital asset-based interaction page 11 when the link is used) to initiate a digital asset-based interaction with the destination computing entity 14. For example, when the destination computing entity 14 is point-of-sale (POS) register and the digital asset-based interaction request link 74 is a scannable code, a display of the destination computing entity 14 displays the digital asset-based interaction request link 74 where a scanning device interface means of the source computing entity 12 is operable to scan the digital asset-based interaction request link 74. As another example, when the destination computing entity 14 is a mobile application installed on the source computing entity 12 and the interface means 18 is a network connection, the digital asset-based interaction request link 74 is provided to the source computing entity 12 via the network connection.

The method continues with step 4 where the source computing entity 12 inputs a set of source inputs 15 via the digital asset-based interaction page 11 which are sent to the digital asset-based interaction computing entity 16. The set of source inputs may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The method may optionally include the digital asset-based interaction computing entity obtaining destination information (e.g., an amount of the digital asset-based interaction, type of desired assets, etc.) from the destination computing entity 14 via the digital asset-based interaction interface 32. In another embodiment, the destination information and/or any other digital asset-based interaction information is contained within the digital asset-based interaction request link 74 such that the source computing entity 12 is operable to view the destination information and/or any other digital asset-based interaction information on the digital asset-based interaction page 11.

The method continues with step 5 where the digital asset-based interaction computing entity 16 generates a digital asset-based interaction request 35 based on the set of source inputs and the destination information. The digital asset-based interaction request 35 is a set of digital asset-based interaction instructions for a particular network. For example, when the set of source inputs identifies Bitcoin as the type of digital asset and Coinbase as the digital asset source (e.g., a particular asset management unit), the digital asset-based interaction computing entity 16 generates a digital asset-based interaction request 35 with instructions on pulling the required amount of Bitcoin from the source computing entity's Coinbase address.

The method continues with steps 6a and 6b which may occur concurrently or slightly before or after one another (e.g., step 6b occurs slightly before step 6a). At step 6a, the digital asset-based interaction computing entity 16 sends the destination computing entity 14 a confirmation that the digital asset-based interaction is successful. At step 6b, the digital asset-based interaction computing entity 16 facilitates the digital asset-based interaction based on the digital asset-based interaction request using a real-time digital asset-based interaction process and a nonreal-time digital asset-based interaction process. The real-time digital asset-based interaction process and a nonreal-time digital asset-based interaction process will be described in greater detail with reference to one or more of the subsequent Figures.

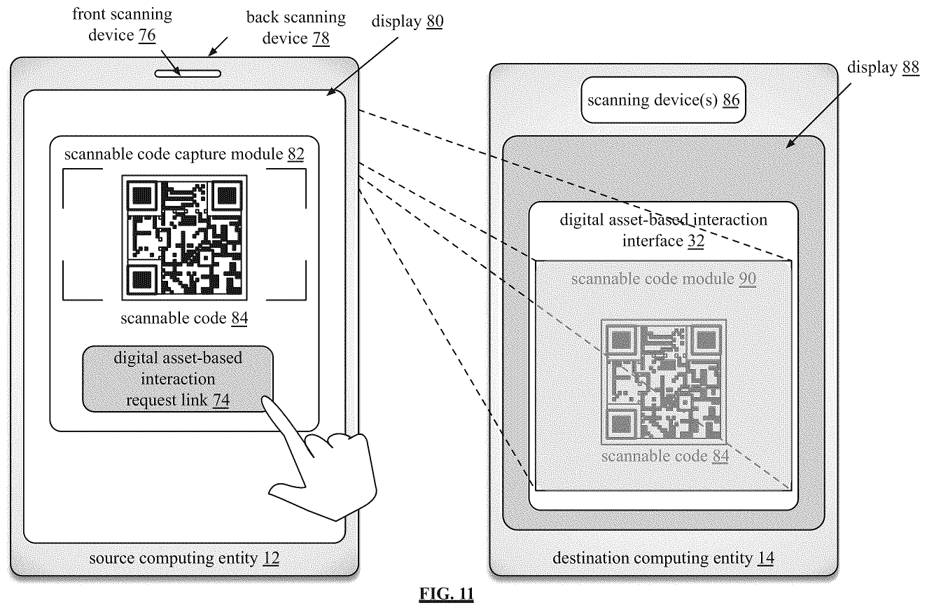

FIG. 11 is a schematic block diagram of an embodiment of a destination computing entity 14 providing a digital asset-based interaction request link 42 to a source computing entity 12. FIG. 11 depicts a user interface perspective of the source computing entity 12 (e.g., a user computing device) interacting with a destination computing entity 14 (e.g., a merchant point-of-sale device). The source computing entity 12 includes a scannable code capture module 82, a display 80, a front scanning device 76, and a back scanning device 78. The front and back scanning devices 76-78 may be a video scanner, camera, infrared (IR), barcode scanners, etc. For example, the source computing entity 12 is a smartphone that has a front and back camera for capturing images.

The source computing entity 12 may include more or less scanning devices than shown and the scanning devices may be positioned in different locations than what is shown. The display 80 may be a liquid crystal display (LCD), a light emitting diode (LED), and/or other type of display technology. In this example, the display 80 is a touchscreen. The touchscreen functionality may be implemented by 5-wire resistive, thin film transistor (TFT), in-place switching (IPS), surface capacitive, surface acoustic wave (SAW), infrared, and/or any other type of touch screen technology. The scannable code capture module 82 is an application installed on the source computing entity 12 that interfaces with the one or more scanning devices 76-78 to capture, display, and/or interpret image data such as photos and scannable codes (e.g., bar codes, quick response (QR) codes, etc.).

The destination computing entity 14 includes one or more scanning devices 86, a display 88, and a digital asset-based interaction interface 32. The one or more scanning devices 86 scanning devices may be a video scanner, camera, infrared (IR), barcode scanners, etc. The display 88 may be a liquid crystal display (LCD), a light emitting diode (LED), and/or other type of display technology. The display 88 may or may not include touchscreen capabilities. The digital asset-based interaction interface 32 is associated with the digital asset-based interaction computing entity. For example, the destination computing entity 14 has an account set up with the digital asset-based interaction computing entity and the digital asset-based interaction interface 32 is a digital asset-based interaction computing entity application installed on the destination computing entity 14 to facilitate digital asset-based interactions.

In an example of operation, the destination computing entity 14 obtains a scannable code 84 (e.g., a QR code) from the digital asset-based computing entity as discussed with reference to FIG. 11 or generates a scannable code 60 associated with a digital asset-based interaction page.

The destination computing entity 14 displays the scannable code 84 on the display 88 via a scannable code module 90 of the digital asset-based interaction interface 32. The source computing entity 12 is operable to capture the scannable code 84 via one or more of its scanning devices 76-78. In this example, the back scanning device 78 scans the scannable code 84. The scannable code capture module 82 is operable to display the scannable code 84 on the display 80 along with the digital asset-based interaction request link 74 that the scannable code 84 is associated with. A user of the source computing entity 12 is then able to select the digital asset-based interaction request link 74.

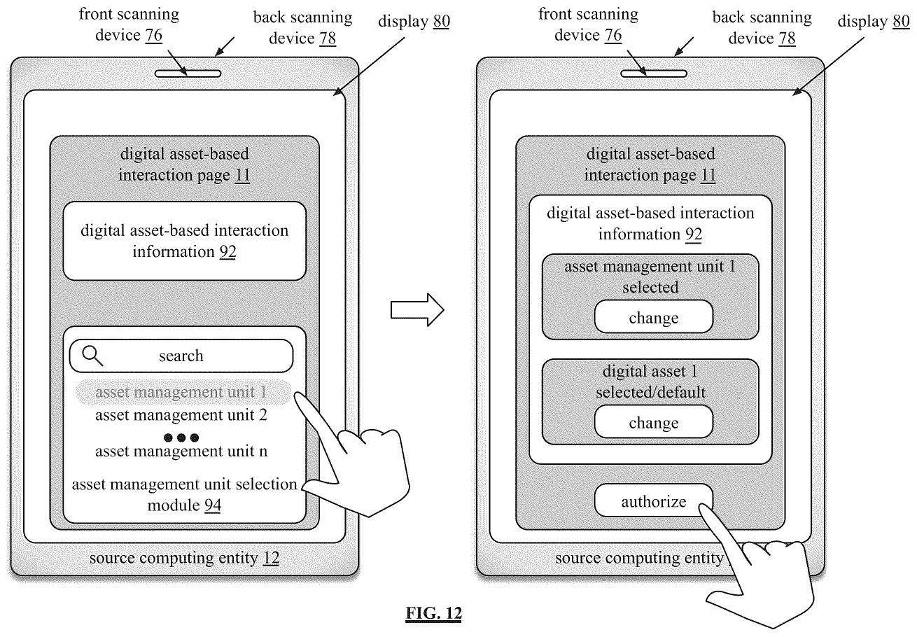

FIG. 12 is a schematic block diagram of an embodiment of a source computing entity 12 providing a set of source inputs to a digital asset-based interaction computing entity 16 via a digital asset-based interaction page 11. FIG. 12 continues the example of FIG. 11 where a user of the source computing entity 12 selects the digital asset-based interaction request link 74. Selecting the digital asset-based interaction request link 74 opens a digital asset-based interaction page 11 that displays digital asset-based interaction information 92 and an asset management unit selection module 94. The asset management unit selection module 94 is a search mechanism operable to allow a user to search and select from a plurality of asset management units available on the source computing entity to use in the digital asset-based interaction. In this example, asset management units 1-n are presented as options for the digital asset-based interaction and the user selects asset management unit 1. In another example, instead of an asset management unit selection module 94, a digital asset selection module is provided that allows a user to select a particular digital asset. Selection of a particular digital asset will then provide asset management unit options that are operable to send the selected digital asset. In another example, a user may be able to choose from a variety of networks for the digital asset-based interaction.

When the user selects the asset management unit 1, the digital asset interaction information 92 is updated to include this selection. By selecting the asset management unit 1, a particular digital asset may be selected or may be a default digital asset of the asset management unit 1. The digital asset-based interaction page 11 may provide an authorize or confirm button to confirm the selections and send the information to the digital asset-based interaction computing entity via the interactive webpage. In another example, selecting the asset management unit and/or the digital asset automatically sends the information to the digital asset-based interaction computing entity via the interactive webpage.

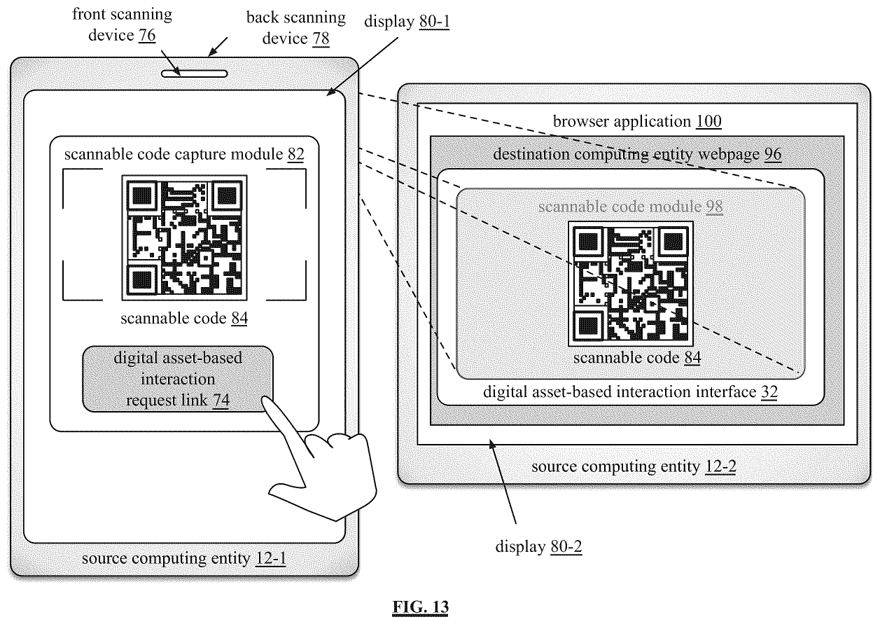

FIG. 13 is a schematic block diagram of another embodiment of a destination computing entity 14 providing a digital asset-based interaction request link 74 to a source computing entity 12. FIG. 13 includes a first source computing entity 12-1 and a second source computing entity 12-2. The first and second source computing entities 12-1 and 12-2 are both associated with a particular user. For example, the first source computing entity 12-1 is a user's smartphone and the second source computing entity 12-2 is the user's desktop computer or laptop.

The embodiment of FIG. 13 is similar to the embodiment of FIG. 11 except that in FIG. 13, the destination computing entity 14 is or is associated with a website (e.g., a destination computing entity webpage 96) accessible via a browser application 100 installed on the second source computing entity 12-2.

In an example of operation, the destination computing entity 14 (e.g., the destination computing entity webpage 96) obtains a scannable code 84 (e.g., a QR code) from the digital asset-based computing entity or generates a scannable code 84 for accessing a digital asset-based interaction page.

The destination computing entity webpage 96 displays the scannable code 84 on the display 80-2 of the source computing entity 12-2. The source computing entity 12-1 is operable to capture the scannable code 84 via one or more of its scanning devices 76-78. In this example, the back scanning device 78 scans the scannable code 84. The scannable code capture module 82 is operable to display the scannable code 84 on the display 80-1 along with a digital asset-based interaction request link 74 that the scannable code 84 is associated with. A user of the source computing entity 12 is then able to select the digital asset-based interaction request link 74.

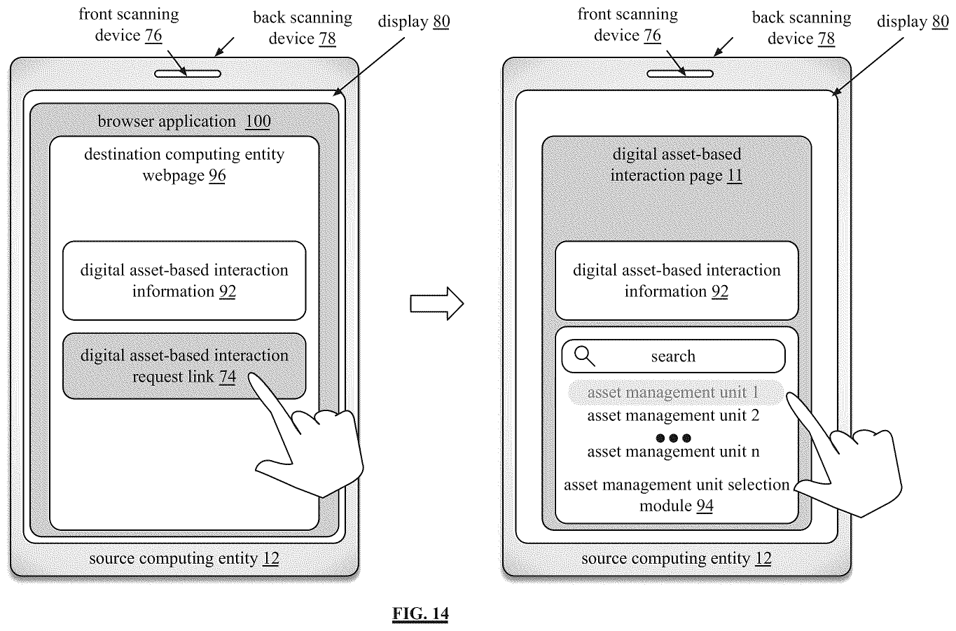

FIG. 14 is a schematic block diagram of another embodiment of a destination computing entity 14 providing a digital asset-based interaction request link 74 to a source computing entity 12. The embodiment of FIG. 14 is similar to the embodiment of FIG. 13 except that the destination computing entity 14 is or is associated with a website (e.g., a destination computing entity webpage 96) accessible via a browser application 100 installed on the source computing entity 12 and instead of scanning a scannable code to obtain a digital asset-based interaction request link, the destination computing entity webpage 96 provides a clickable digital asset-based interaction request link 74 (e.g., a URL link, a URL link via a “pay” or “checkout” button, etc.).

Selecting the digital asset-based interaction request link 74 opens a digital asset-based interaction page 11 that displays digital asset-based interaction information 92 and an asset management unit selection module 94. The asset management unit selection module 94 is a search mechanism operable to allow a user to search and select from a plurality of asset management units available on the source computing entity to use in the digital asset-based interaction. In this example, asset management units 1-n are presented as options for the digital asset-based interaction and the user selects asset management unit 1. In another example, instead of an asset management unit selection module 94, a digital asset selection module is provided that allows a user to select a particular digital asset. Selection of a particular digital asset will then provide asset management unit options that are operable to send the selected digital asset.

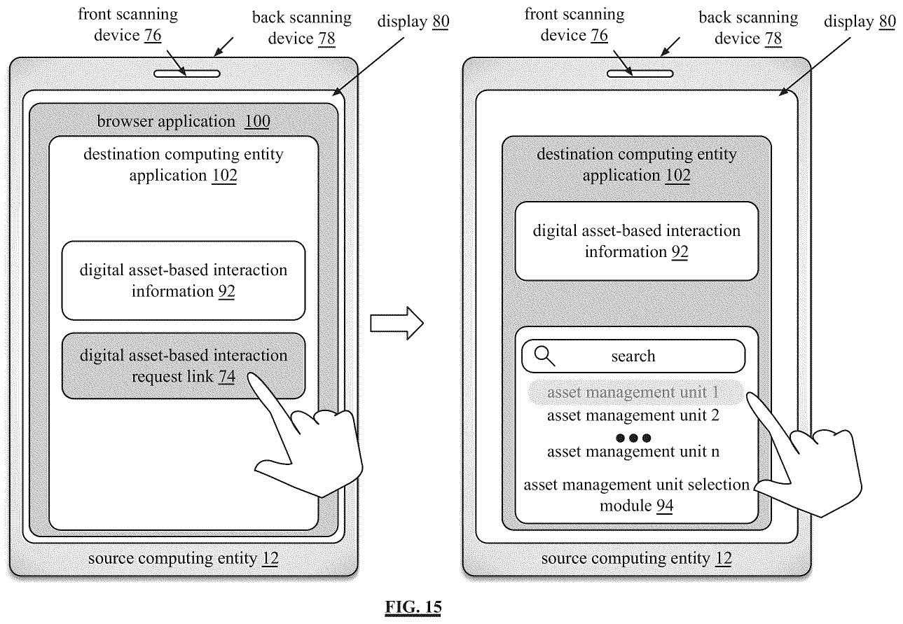

FIG. 15 is a schematic block diagram of an embodiment of a source computing entity 12 that includes a destination computing entity application 102. FIG. 15 operates similarly to the example of FIG. 14 except that instead of accessing a website associated with the destination computing entity, the source computing entity 12 includes a destination computing entity application 102. During a checkout function, the destination computing entity application 102 may present a digital asset-based interaction request link 74 (e.g., a “pay with digital asset” button) and other digital asset-based interaction information 92.

Selecting the digital asset-based interaction request link 74 opens a digital asset-based interaction page 11 that displays digital asset-based interaction information 92 and an asset management unit selection module 94. The asset management unit selection module 94 is a search mechanism operable to allow a user to search and select from a plurality of asset management units available on the source computing entity to use in the digital asset-based interaction. In this example, asset management units 1-n are presented as options for the digital asset-based interaction and the user selects asset management unit 1. In another example, instead of an asset management unit selection module 94, a digital asset selection module is provided that allows a user to select a particular digital asset. Selection of a particular digital asset will then provide asset management unit options that are operable to send the selected digital asset.

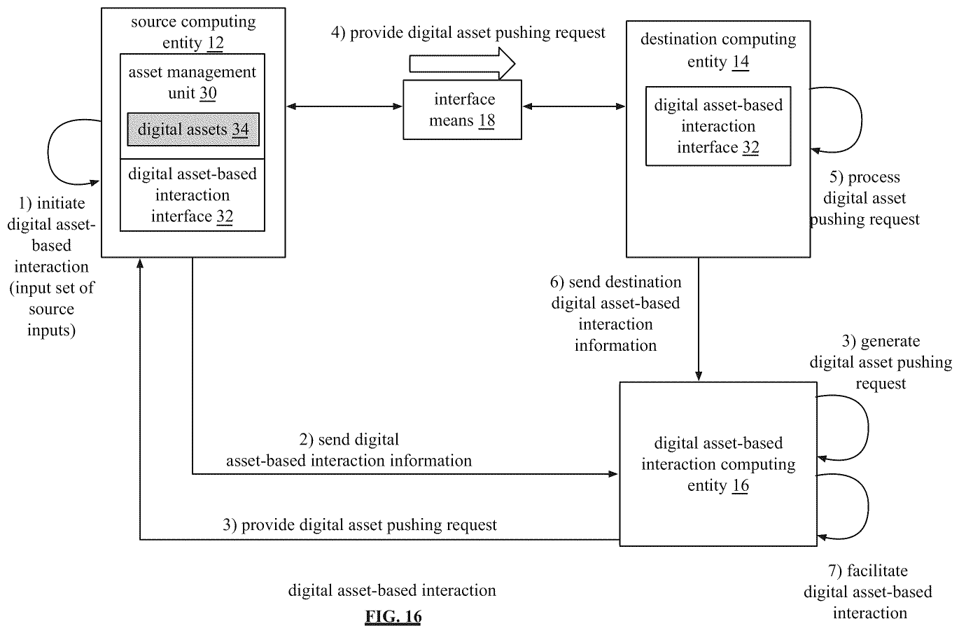

FIG. 16 is a flowchart of an example of a method of a digital asset-based interaction using a digital asset pushing request. In FIG. 16, the source computing entity 12 includes an asset management unit 30 that stores digital assets 34 and is associated with the digital asset-based interaction computing entity 16 via a digital asset-based interaction interface 32. The method begins with step 1 where the source computing entity 12 inputs a set of source inputs to the digital asset-based interaction computing entity 16 via the digital asset-based interaction interface 32. For example, the source computing entity 12 is operable to select a destination computing entity (e.g., via a searchable list of nearby merchants), a type of digital asset for a digital asset-based interaction, and a source of the digital asset (e.g., a particular asset management unit).

The method continues with step 2 where the source computing entity 12 sends digital asset-based interaction information to the digital asset-based interaction computing entity 16 via the digital asset-based interaction interface 32. The digital asset-based interaction information includes the set of source inputs (e.g., a source ID, a type of digital asset, etc.), and may further include an amount of the digital asset-based interaction, a type of digital asset-based interaction, one or more items included in a digital asset-based interaction, destination computing entity information (e.g., a merchant ID, etc.), etc.

Based on the digital asset-based interaction information, the method continues with step 3 where the digital asset-based interaction computing entity 16 generates and provides a digital asset pushing request to the source computing entity 12. For example, the digital asset pushing mechanism is a scannable code that authorizes an amount of digital assets to be pushed to a location. At step 4, the source computing entity 12 provides the digital asset pushing mechanism to the destination computing entity 14 via one or more interface means 18. The format of the digital asset pushing request generated may depend on the POS requirements of the destination computing entity 14. For example, a scannable code generated depends on the scanning technology used by the destination computing entity. A destination computing entity may also require the digital asset-based computing entity 16 to generate and send a verification code along with a scannable code. For example, a verification code is an alpha numeric code that can be manually entered or scanned by the destination computing entity.

The digital asset pushing request authorizes a digital asset-based interaction for up to a certain amount (e.g., X amount) for a time period (e.g., 5-30 seconds). The certain amount authorized may be based on one or more of the amount of system digital asset locked, the source computing entity 12, and the destination computing entity 14.

The time period may be a few seconds up to a few minutes of time depending on the source computing entity 12, the type of digital asset-based interaction, and/or the destination computing entity 14. For example, a fast food retail payment may have a shorter time period than a car purchase payment because the car purchase may involve lengthy paperwork and identity verification checks coinciding with payment. If the time period expires prior to real-time digital asset-based interaction confirmation, the digital asset pushing mechanism may no longer be valid and the source computing entity will need to request a new digital asset pushing request. Alternatively, the digital asset-based interaction computing entity 16 may automatically send a new digital asset pushing request to the source computing entity 12 every few seconds for a time period (e.g., up to 5 minutes) before the source computing entity 12 would need to request a new authorization scannable code.

At step 5, the destination computing entity 14 processes the digital asset pushing request (e.g., scans the scannable code via a scanning device of the destination computing entity 14). For example, a user of the source computing entity 12 places the source computing entity 12 display near a scanning device of the destination computing entity 14 (e.g., the destination computing entity 14 is a tablet and the scanning device is a front or back camera) for the destination computing entity 14 to capture a scannable code digital asset pushing request. In that example, the destination computing entity 14 may be an unattended POS register (e.g., at a retail kiosk, self-checkout location, a gas pump checkout, a vending machine, etc.).

The method continues with step 6 where, when the destination computing entity 14 processes the digital asset pushing request, the destination computing entity 14 sends destination digital asset-based interaction information to the digital asset-based interaction computing entity 16. The destination digital asset-based interaction information includes an identifier (ID) (e.g., a merchant ID) and a type of desired digital asset (e.g., a fiat currency, a different cryptocurrency, etc.) it wishes to receive in the digital asset-based interaction with the source computing entity 12. The destination digital asset-based interaction information also includes the amount of the digital asset-based interaction in this example. The destination digital asset-based interaction information may include other information and/or metadata such as discounts offered and/or applied, shipping details (rates, method, etc.), bill splitting options, etc.

When the digital asset-based interaction computing entity 16 receives the destination digital asset-based interaction information, the method continues with step 7 where the digital asset-based interaction computing entity 16 goes on to facilitate the digital asset-based interaction.

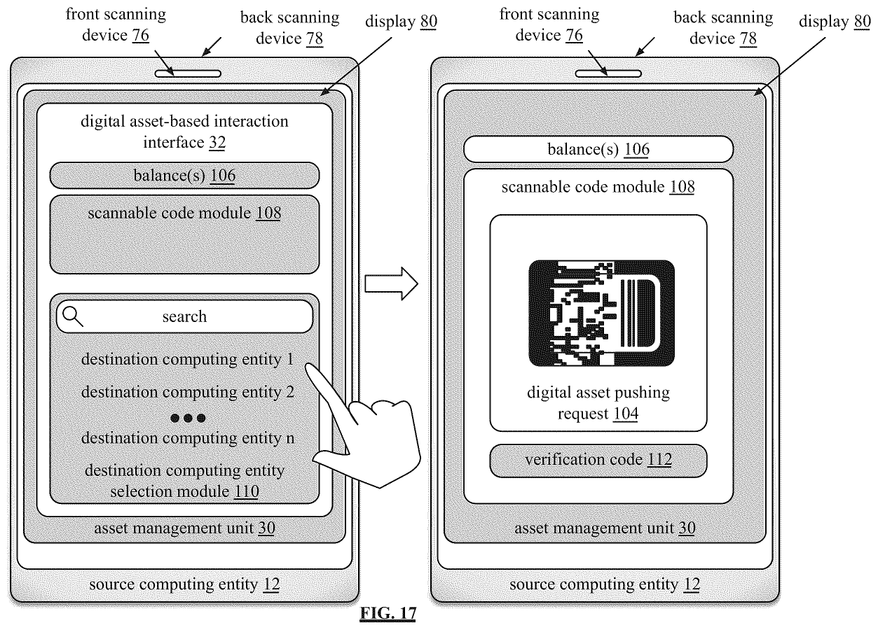

FIG. 17 is a schematic block diagram of a source computing entity 12 that includes an asset management unit 30 having a digital asset-based interaction interface 32 associated with a digital asset-based interaction computing entity. The digital asset-based interaction interface 32 interfaces with the digital asset-based interaction computing entity. FIG. 17 depicts a user interface perspective of the source computing entity 12 and further includes a display 80, a front scanning device 76, and a back scanning device 78.

In the user interface perspective, the digital asset-based interaction interface 32 includes balances 106, a scannable code module 108, and a destination computing entity selection module 110. The balance(s) 106 may include account balances for a variety of digital assets (e.g., cryptocurrencies, fiat, etc.) of a variety of asset management units. The balance(s) 106 are based on rate quotes determined by a digital asset exchange computing entity used by the digital asset-based interaction computing entity 16 at a point in time (e.g., a current exchange rate, an average exchange rate for a time period, etc.). The scannable code module 108 is operable to display scannable codes on the display 80 and interpret scannable codes captured via the scanning devices. The destination computing entity selection module 110 is operable to connect to the digital asset-based interaction computing entity and/or a database associated with the digital asset-based interaction computing entity to receive destination computing entity data (e.g., a list of merchants associated with the digital asset-based interaction system).

The destination computing entity selection module 110 may display a list of merchants that are associated with the digital asset-based interaction system for selection by the source computing entity 12. The destination computing entity selection module 110 includes a search function to allow a user to search for a desired destination computing entity. The displayed list of destination computing entities may be based on location (e.g., nearby merchants are listed), category (e.g., restaurant merchants are listed), and/or availability (e.g., according to hours of operation). In another embodiment, the source computing entity 12 is able to locate and initiate a digital asset-based interaction with user computing device of the digital asset-based interaction system (e.g., where destination computing entity selection module 110 further includes a user computing device selection function).

Referring to the method of FIG. 16, a user of the source computing entity 12 initiates a digital asset-based interaction by selecting a destination computing entity (destination computing entity 1 in this example) from a displayed list of destination computing entities in the destination computing entity selection module 110. When selected, the source computing entity 12 receives a digital asset pushing request 104 (shown here as a scannable code and a verification code 112) (e.g., the destination computing entity 14 requires a verification code along with a scannable code to authorize the digital asset-based interaction) from the digital asset-based interaction computing entity. The digital asset pushing request 104 and the verification code 112 are displayed within the scannable code module 108 of the source computing entity's 12 display 80. The source computing entity 12 is operable to present the digital asset pushing request 104 and the verification code 112 to a destination computing entity to engage in a digital asset-based interaction.

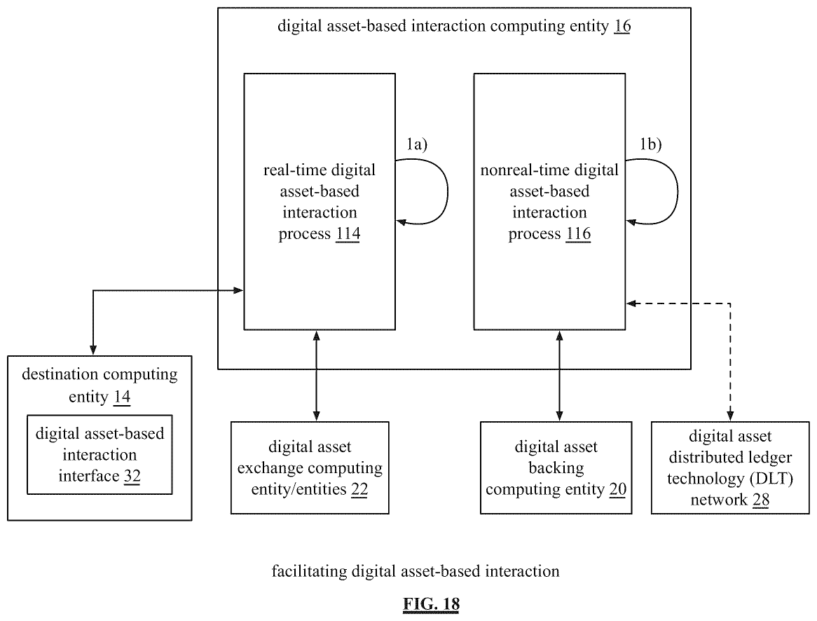

FIG. 18 is a flowchart of an example of a method of a digital asset-based interaction computing entity 16 facilitating a digital asset-based interaction between a source computing entity and a destination computing entity. FIG. 18 depicts a portion of a digital asset-based interaction system that includes a destination computing entity 14, a digital asset-based interaction computing entity 16, one or more digital asset exchange computing entities 22, a digital asset distributed ledger (DLT) network 28, and a digital asset backing computing entity 20.

FIG. 18 continues the examples of previous Figures when the digital asset-based interaction computing entity 16 facilitates the digital asset-based interaction by executing steps 1a and 1b. Steps 1a and 1b may occur simultaneously or at slightly different times (e.g., step 1b may occur slightly before step 1a and vice versa).

At step 1a, the digital asset-based interaction computing entity 16 performs a real-time digital asset-based interaction process 114 ensure complete the real-time digital asset-based interaction between the source and destination computing entities 12-14. To perform the real-time digital asset-based interaction process, the digital asset-based interaction computing entity 16 is operable to connect to the one or more digital asset exchange computing entities 22 to convert the digital assets 34 to a substantially equivalent amount of desired assets (e.g., fiat currency, another digital asset, whatever asset format is desired by the destination computing entity 14) and send the desired assets to the destination computing entity 14. The real-time digital asset-based interaction process 86 will be discussed in greater detail with reference to FIGS. 19 and 21-23.

At step 1b, the digital asset-based interaction computing entity 16 performs a nonreal-time digital asset-based interaction process 116 to reconcile the real-time digital asset-based interaction process with the digital asset backing computing entity 20. To perform the nonreal-time digital asset-based interaction process 116, the digital asset-based interaction computing entity 16 is operable to communicate with the digital asset backing computing entity 20 to back digital asset-based interactions such that they can be authorized and/or completed successfully in real-time and connect to the digital asset DLT network 28 associated with the digital assets 34 to verify receipt of digital assets 34. In another embodiment, the digital asset-based interaction computing entity 16 includes the digital asset backing computing entity 20. The nonreal-time digital asset-based interaction process will be discussed in greater detail with reference to FIGS. 20 and 24A-24C.

FIG. 19 is a flowchart of an example of a method of a real-time digital asset-based interaction process 114 executable by a digital asset-based interaction computing entity of a digital asset-based interaction system. The method begins with step 118 where the digital asset-based interaction computing entity obtains an amount of digital assets from a source computing entity to use in a digital asset-based interaction. The digital asset-based interaction involves a source computing entity providing digital assets and a destination computing entity accepting desired assets. The destination computing entity is associated with the digital asset-based interaction computing entity.

When the amount of the digital assets obtained by the digital asset-based interaction computing entity from the source computing entity to use in the digital asset-based interaction, a network acknowledgment (ACK) of the receipt of the amount of the digital assets is generated and an authorization process begins. The authorization process will be discussed in more detail with reference to FIGS. 26-28.

Because the digital assets sent by the source computing entity are managed by a digital asset distributed ledger technology network (e.g., the digital assets are cryptocurrency), sending the amount of digital assets to the digital asset-based interaction computing entity is a transaction added to the digital asset DLT network associated with the digital assets used by the source computing entity (e.g., this information is published). However, other details related to the interaction (e.g., the identity of the destination computing entity, transaction fees owed by the destination computing entity, etc.) may be managed privately by the digital asset-based interaction computing entity off-ledger (i.e., off-chain when the distributed ledger technology is blockchain). Therefore, the digital asset-based interaction system is operable to keep confidential destination computing entity related information (e.g., revenue, consumer spending behavior, etc.) and confidential source computing entity related information (e.g., consumer identity of purchases, amount spent at a particular merchant, payees/merchants frequented, etc.) private (i.e., not published on a blockchain for anyone to see).

When the digital asset-based interaction is authorized (e.g., the authorization process is successful), the method continues with step 120 where the digital asset-based interaction computing entity connects to one or more digital asset exchange entities to exchange the amount of the digital assets received from the source computing entity to an amount of desired assets. Digital asset exchange is done quickly (e.g., 30 seconds to a few minutes) to account for exchange rate volatility. The exchange can also be performed immediately on a credit-based account to eliminate any pricing volatility.

The method continues with step 122 where the digital asset-based interaction computing entity sends the amount of desired assets to the destination computing entity. For example, the digital asset-based interaction computing entity sends the desired assets to a banking computing entity associated with the destination computing entity. As another example, the digital asset-based interaction computing entity directs the desired assets to a wallet address associated with the destination computing entity.

FIG. 20 is a flowchart of an example of a method of a nonreal-time digital asset-based interaction process 116 executable by a digital asset-based interaction computing entity of a digital asset-based interaction system. The nonreal-time digital asset-based interaction process 116 of FIG. 20 occurs concurrently with the real-time digital asset-based interaction process 114 of FIG. 19. However, the nonreal-time digital asset-based interaction process 116 occurs over a longer period of time (e.g., minutes to hours) than the real-time digital asset-based interaction process 114 (e.g., seconds).

The method begins with step 124 where the digital asset-based interaction computing entity instructs a digital asset backing computing entity of the digital asset-based interaction system to lock an amount of system digital assets stored in a transformer pool associated with the digital asset distributed ledger technology (DLT) network associated with the digital assets involved in the digital asset-based interaction. The digital asset-based interaction involves a source computing entity providing the digital assets and a destination computing entity accepting desired assets. The destination computing entity is associated with the digital asset-based interaction computing entity.

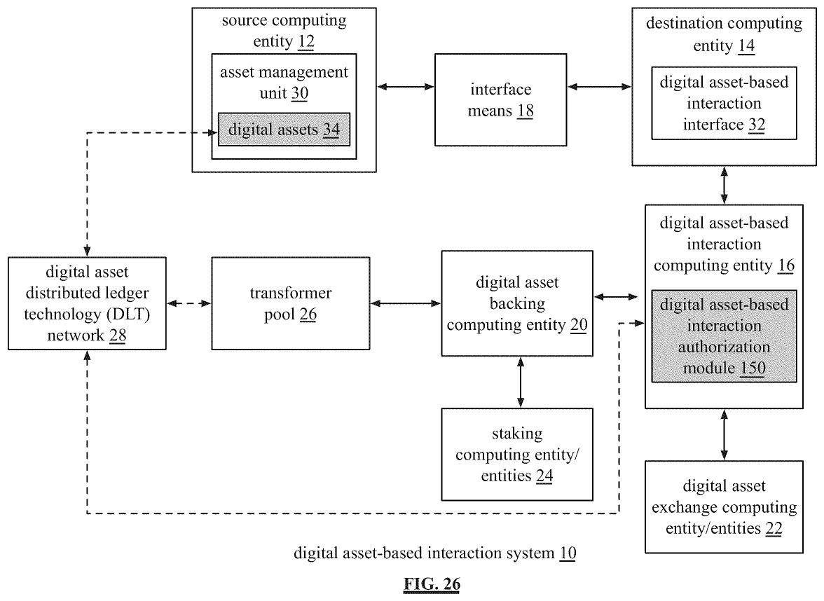

The digital asset backing computing entity may be a part of or separate from the digital asset-based interaction computing entity. The digital asset backing computing entity manages the storage and use of system digital assets (e.g., system cryptocurrency, system tokens, etc.) for collaterally backing digital asset-based interactions. System digital assets are digital assets that serve as collateral to back digital asset-based interactions of the digital asset-based interaction system. One or more staking computing entities provide the digital asset backing computing entity with system digital assets and instructions on how to stake the system digital assets. For example, one or more staking computing entities provided the digital asset backing computing entity system digital assets to back a digital asset DLT network associated with the digital assets used by the source computing entity in the digital asset-based interaction. A transformer pool is a smart contract that stores system digital assets to back the digital asset DLT network. The one or more staking computing entities, the digital asset backing computing entity, and the transformer pool will be discussed in more detail with reference to FIG. 25.

The amount of system digital assets locked may be based on a variety of factors such as the amount of the digital asset-based interaction (e.g., the amount of system digital assets is substantially equivalent to the amount of the digital asset-based interaction), the item involved in the digital asset-based interaction (e.g., the amount of system digital assets may be a certain amount more than the amount of the digital asset-based interaction when certain types of goods, such as luxury goods, are involved), source computing entity information (e.g., if the source computing entity has a history of fraudulent interactions, the amount of system digital assets may be a certain amount more than the amount of the digital asset-based interaction), destination computing entity information (e.g., merchant-based requirements, default settings), a type of digital asset-based interaction (e.g., authorization holds such as for hotel room purchase may require a certain amount of system digital assets more than the amount of the digital asset-based interaction), digital asset backing computing entity default settings, etc.

If the digital asset-based interaction initiation is terminated (e.g., interaction initiation fails and/or is cancelled by the source and/or the destination computing entity) or the digital asset-based interaction is not authorized during the authorization process within a certain amount of time prior to the digital asset-based interaction computing entity exchanging the digital assets to the desired asset format (e.g., step 120 of FIG. 19), the digital asset-based interaction computing entity instructs the digital asset backing computing entity to release the amount of locked system digital assets (e.g., the method branches to step 124).

Step 124 of FIG. 20 may occur before, concurrently, or after step 118 (but before step 120 of FIG. 19. If step 124 occurs before step 118 of FIG. 19, an acknowledgement (ACK) may be generated. For example, locking the system digital assets implies authorization of the digital asset-based interaction, and the digital asset-based interaction computing entity allows a time period (e.g., up to five minutes) prior to obtaining digital assets from the source computing entity (e.g., the first computing entity has time to add tip, split payment with another user, adjust type of digital asset used, etc.). The destination computing entity is provided a confirmation of this ACK. For example, when the destination computing entity is a POS computing device such as an attended register, this ACK may successfully end the in-person transaction such that a merchant and customer can part ways. However, the destination computing entity receives the payment up to a few minutes later.

When the digital asset backing computing entity locks the amount of the system digital assets, a rate quote for the amount of digital assets used by the source computing entity is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 126 where the digital asset-based interaction computing entity connects to the digital asset DLT network associated with the digital assets used by the source computing entity to verify obtaining the digital assets. The digital asset DLT network implements a validation procedure that may take minutes to hours of time.

For example, in the Bitcoin blockchain, miners record new transactions into blocks that verify all previous transactions within the blockchain. At the filing of this application, it takes a miner ten minutes, on average, to write a block on the Bitcoin blockchain. The average block time depends on a total hash power of the Bitcoin network. Once a block is created and a new transaction is verified and included in a block, the transaction will have one confirmation. Each subsequent block (which verifies the previous state of the blockchain) provides one additional network confirmation.

Typically, between 5-10 transaction confirmations (depending on the monetary value of the transaction) are acceptable for cryptocurrency exchanges to avoid losses due to potential fraud. Therefore, if the source computing entity is using Bitcoin, the digital asset-based interaction computing entity seeks a desired number of confirmations of the amount of the Bitcoin received by the source computing entity from the digital asset DLT network (e.g., via Bitcoin miners). The transaction may not be verified by the digital asset-based interaction computing entity for an hour or more. As such, the nonreal-time digital asset-based interaction process takes longer than the real-time digital asset-based interaction process of the digital asset-based interaction.

The method continues with step 128 where the digital asset-based interaction computing entity determines whether the amount of digital assets is verified (e.g., the digital asset-based interaction computing entity obtains results from the digital asset DLT network regarding whether the amount of the digital assets is verified). When the amount of digital assets is verified, the method continues with step 132 where the digital asset-based interaction computing entity instructs the digital asset backing computing entity to release the amount of system digital assets associated with the digital asset-based interaction. When the amount of digital assets is not verified, the method continues with step 130 where the digital asset-based interaction computing entity instructs the digital asset backing computing entity to consume at least a portion of the amount of system digital assets associated with the digital asset-based interaction.

For example, if fraudulent activity occurs (e.g., the source computing entity acts maliciously to spend at two merchants simultaneously, software of the asset management unit is corrupted, etc.), the amount of the digital assets cannot be verified and the digital asset-based interaction computing entity consumes at least a portion of the amount of system digital assets associated with the digital asset-based interaction. As a specific example, if the source computing entity attempts to double spend a transaction, the verification (e.g., the desired number of confirmations in a Bitcoin blockchain example) will not be received and the digital asset-based interaction computing entity will not be able to verify the amount of the digital asset received by the source computing entity.

Consuming the amount of system digital assets means that the amount of system digital assets is transferred (e.g., via an on-chain transaction) from an address associated with the transformer pool to an address associated with the digital asset-based interaction computing entity. When the amount of system digital assets is more than the amount of the digital asset-based interaction, only a portion of the amount of system digital assets (to cover the digital asset-based interaction) may be consumed while the remainder is unlocked. In another example, regardless of whether the amount of system digital assets is more than the amount of the digital asset-based interaction, the entire amount of the of system digital assets may be consumed.

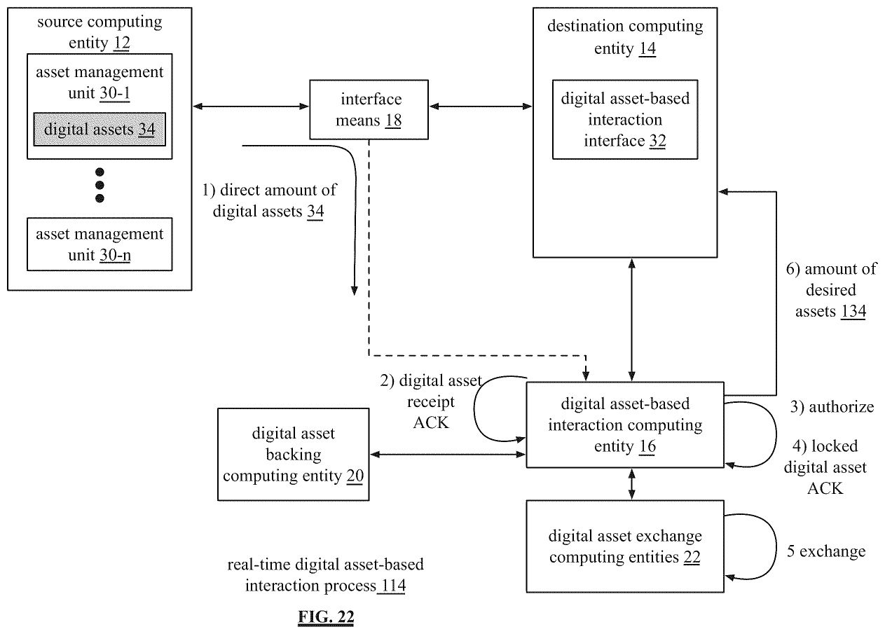

FIG. 21 is a flowchart of an example of a method of a real-time digital asset-based interaction process 114 executable by a digital asset-based interaction computing entity 16 of a digital asset-based interaction system. FIG. 21 depicts a portion of the digital asset-based interaction system 10 that includes a source computing entity 12, a destination computing entity 14, an interface means 18, a digital asset-based interaction computing entity 16, a digital asset backing computing entity 20, and one or more digital asset exchange computing entities 22.

The source computing entity 12, the destination computing entity 14, the interface means 18, the digital asset-based interaction computing entity 16, the digital asset backing computing entity 20, and the one or more digital asset exchange computing entities 22 of FIG. 17 operate similarly to the source computing entity 12, the destination computing entity 14, the interface means 18, the digital asset-based interaction computing entity 16, the digital asset backing computing entity 20, and the one or more digital asset exchange computing entities 22 of FIG. 1.

The destination computing entity 14 may be a merchant computing entity that is operable to process payments from a source computing entity and includes features tailored to the type of destination computing entity 14 it is (e.g., a scanning device, a touchscreen, mobile payment features, online payment features, etc.). The source computing entity 12 and the destination computing entity 14 interact via one or more interface means 18 to initiate a digital asset-based interaction. For example, an interface means 18 is a scanning device of the source computing entity 12 and/or the destination computing entity 14. A digital asset-based interaction involves the source computing entity 12 providing digital assets and the destination computing entity 14 accepting desired assets (e.g., fiat currency or a desired digital asset that differs from the digital asset the source computing entity 12 wishes to use in the interaction).

The method begins with step 1 where the source computing entity 12 directs an amount of digital assets 34 to the digital asset-based interaction computing entity 16 via the interface means 18. For example, the destination computing entity 14 provides the source computing entity 12 with a digital asset-based interaction request link (e.g., via a scannable code, a uniform resource locator (URL) link, etc.) to a digital asset-based interaction page that allows the source computing entity 12 to push digital assets to an address associated with the digital asset-based interaction computing entity 16. In this example, the source computing entity 12 is not associated with the digital asset-based interaction computing entity 16 so funds are pushed from the source computing entity 12 to the digital asset-based interaction computing entity 16.

The method continues with step 2 where a network acknowledgment (ACK) of the receipt of the amount of the digital assets and system digital assets locked (e.g., the nonreal-time digital asset-based interaction process step of locking system digital assets occurs before, concurrently, or slightly after the digital assets are obtained) is generated. The method continues with step 3 where an authorization process begins. Authorizing the digital asset-based interaction after locking the system digital assets may be useful when there are multiple parties sharing the same ticket which would require the digital asset-based interaction computing entity 16 to collateralize each digital asset-based interaction involved (where each would need to be authorized separately). The authorization process will be discussed in more detail with reference to FIGS. 26-28.

When the authorization process is successful, the method continues with step 4 where the digital asset-based interaction computing entity 16 connects to one or more digital asset exchange entities 22 to exchange the amount of the digital assets 34 received from the source computing entity 12 to an amount of desired assets 134 (e.g., fiat currency, a digital asset that differs from the digital assets 34). Digital asset exchange is done quickly (e.g., 30 seconds to a few minutes) to account for exchange rate volatility. The exchange can also be performed immediately on a credit-based account to eliminate any pricing volatility.

The method continues with step 5 where the digital asset-based interaction computing entity 16 sends the amount of the desired assets 134 to the destination computing entity 14. For example, the digital asset-based interaction computing entity 16 sends the amount of the desired assets 106 to a banking computing entity associated with the destination computing entity 14. As another example, the digital asset-based interaction computing entity 16 directs the amount of the desired assets 134 to a wallet address associated with the destination computing entity 14.

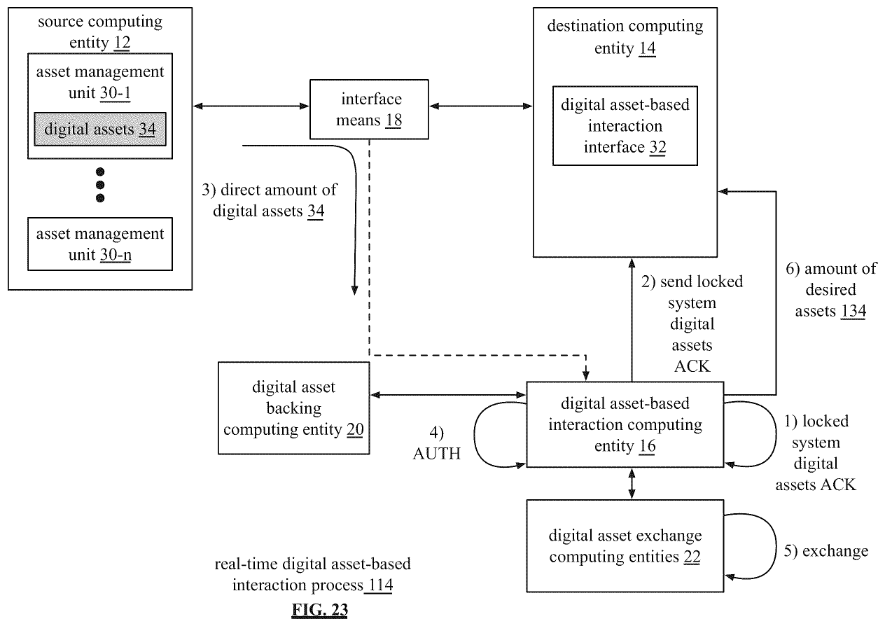

FIG. 22 is a flowchart of an example of a method of a real-time digital asset-based interaction process 114 executable by a digital asset-based interaction computing entity 16 of a digital asset-based interaction system 10. FIG. 22 depicts a portion of the digital asset-based interaction system 10 that includes a source computing entity 12, a destination computing entity 14, an interface means 18, a digital asset-based interaction computing entity 16, a digital asset backing computing entity 20, and one or more digital asset exchange computing entities 22. FIG. 22 operates similarly to the method of FIG. 21 except that the authorization process at step 3 occurs before the locked digital asset acknowledgment (ACK) is generated at step 4 and the locked system digital asset ACK is separate from the digital assets received ACK.

Locking the system digital assets after authorizing the digital asset-based interaction may be useful when authorizing straightforward digital asset-based interactions (e.g., a consumer paying for purchase at an apparel retailer). This would help reduce the unnecessary overhead of locking system digital assets for digital asset-based interactions that are declined. The authorization process will be discussed in more detail with reference to FIGS. 26-28.

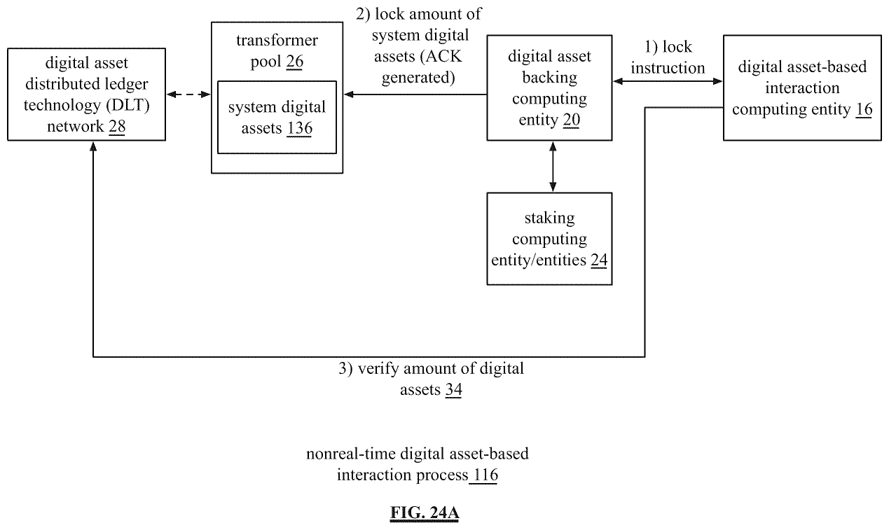

FIG. 23 is a flowchart of an example of a method of a real-time digital asset-based interaction process 86 executable by a digital asset-based interaction computing entity 16 of a digital asset-based interaction system. FIG. 23 depicts a portion of the digital asset-based interaction system that includes a source computing entity 12, a destination computing entity 14, an interface means 18, a digital asset-based interaction computing entity 16, a digital asset backing computing entity 20, and one or more digital asset exchange computing entities 22.

The method of FIG. 23 is similar to the method of FIG. 21 except that at step 1, an acknowledgment (ACK) is generated when an amount of system digital assets is locked to back the digital asset-based interaction (e.g., the digital assets have not been received yet). For example, locking the system digital assets (a step that occurs during the concurrent nonreal-time digital asset-based interaction process) implies authorization of the digital asset-based interaction, and the digital asset-based interaction computing entity 16 allows a time period (e.g., up to five minutes) prior to obtaining digital assets from the source computing entity (e.g., the first computing entity has time to add tip, split payment with another user, adjust type of digital asset used, etc.).

The method continues at step 2, where the digital asset-based interaction computing entity 16 sends the ACK to the destination computing entity 14. For example, when the destination computing entity is a POS computing device such as an attended register, this ACK may successfully end the in-person transaction such that a merchant and customer can part ways. However, the destination computing entity receives the payment up to a few minutes later.

The method continues with step 3 where the source computing entity 12 directs an amount of digital assets 34 to the digital asset-based interaction computing entity 16 via the interface means 18. For example, the destination computing entity 14 provides the source computing entity 12 with a digital asset-based interaction request link (e.g., via a scannable code, a uniform resource locator (URL) link, etc.) to a digital asset-based interaction page that provides the source computing entity 12 the ability to push digital assets to an address associated with the digital asset-based interaction computing entity 16 (e.g., via an interactive webpage). In this example, the source computing entity 12 is not associated with the digital asset-based interaction computing entity 16 so funds are pushed from the source computing entity 12 to the digital asset-based interaction computing entity 16.

The method continues with step 4 where receipt of the amount of the digital assets is generated, and an authorization process begins. The authorization process will be discussed in more detail with reference to FIGS. 26-28. When the authorization process is successful, the method continues with step 5 where the digital asset-based interaction computing entity 16 connects to one or more digital asset exchange entities 22 to exchange the amount of the digital assets 34 received from the source computing entity 12 to an amount of desired assets 134. Digital asset exchange is done quickly (e.g., 30 seconds to a few minutes) to account for exchange rate volatility. The exchange can also be performed immediately on a credit-based account to eliminate any pricing volatility.

The method continues with step 6 where the digital asset-based interaction computing entity 16 sends the amount of the desired assets 134 to the destination computing entity 14. For example, the digital asset-based interaction computing entity 16 sends the amount of the desired assets 134 to a banking computing entity associated with the destination computing entity 14. As another example, the digital asset-based interaction computing entity 16 directs the amount of the desired assets 106 to a wallet address associated with the destination computing entity 14.

FIGS. 24A-24C are flowcharts of an example of a method of a nonreal-time digital asset-based interaction process 116 executable by a digital asset-based interaction computing entity of a digital asset-based interaction system. FIGS. 24A-24C depict a portion of the digital asset-based interaction system that includes a digital asset-based interaction computing entity 16, a digital asset backing computing entity 20, one or more staking computing entities 24, a transformer pool 26, and a digital asset distributed ledger technology (DLT) network 28.

The nonreal-time digital asset-based interaction process 116 of FIGS. 24A-24C begins concurrently with the real-time digital asset-based interaction process 114 of FIGS. 21-23. However, the nonreal-time digital asset-based interaction process 116 occurs over a longer period of time (e.g., minutes to hours) than the real-time digital asset-based interaction process 114 (e.g., seconds).

The method begins with FIG. 24A at step 1 where the digital asset-based interaction computing entity 16 instructs the digital asset backing computing entity 20 of the digital asset-based interaction system to lock an amount of system digital assets 136 associated with a digital asset-based interaction. The digital asset-based interaction involves a source computing entity providing digital assets and a destination computing entity accepting desired assets. The destination computing entity is associated with the digital asset-based interaction computing entity.

The digital asset backing computing entity 20 may be a part of or separate from the digital asset-based interaction computing entity 16. The digital asset backing computing entity 20 manages the storage and use of system digital assets 136 (e.g., system cryptocurrency, system tokens, etc.) for collaterally backing digital asset-based interactions. System digital assets 136 are digital assets that serve as collateral to back digital asset-based interactions of the digital asset-based interaction system.

One or more staking computing entities 24 provide the digital asset backing computing entity 20 with system digital assets 136 and instructions on how to stake the system digital assets 136. In this example, the one or more staking computing entities 24 provided the digital asset backing computing entity 20 system digital assets 136 to back a digital asset DLT network 28 associated with the digital assets used by the source computing entity in the digital asset-based interaction. The digital asset backing computing entity 20 deposits system digital assets 108 in a transformer pool 26 associated with the digital asset DLT network 28 to back digital asset-based interactions associated with the digital asset DLT network 28. The transformer pool 26 is a smart contract that stores system digital assets 108 to back the digital asset DLT network 28. The one or more staking computing entities, the digital asset backing computing entity, and the transformer pool will be discussed in more detail with reference to FIG. 25.

The method continues with step 2 where the digital asset backing computing entity 20 locks an amount of system digital assets 136 within the transformer pool 26 to back the digital asset-based interaction. A system acknowledgment (ACK) that the system digital assets have been locked may be generated. The ACK triggers a portion of the real-time digital asset-based interaction process (e.g., digital asset exchange can occur now that the system digital assets are locked, etc.) or can end an in-person transaction where the ACK serves as authorization of the digital asset-based interaction.

The amount of system digital assets locked may be based on a variety of factors such as the amount of the digital asset-based interaction (e.g., the amount of system digital assets is substantially equivalent to the amount of the digital asset-based interaction), the item involved in the digital asset-based interaction (e.g., the amount of system digital assets may be more than the amount of the digital asset-based interaction when certain types of goods, such as luxury goods, are involved), source computing entity information (e.g., if the source computing entity has a history of fraudulent interactions, the amount of system digital assets may be more than the amount of the digital asset-based interaction), destination computing entity information (e.g., merchant-based requirements, default settings), a type of digital asset-based interaction (e.g., authorization holds such as for hotel room purchase may require a larger amount of system digital assets than the amount of the digital asset-based interaction), digital asset backing computing entity 16 default settings, etc.

If the digital asset-based interaction initiation is terminated (e.g., interaction initiation fails and/or is cancelled by the source and/or the destination computing entity) or the digital asset-based interaction is not authorized during the authorization process within a certain amount of time prior to the digital asset-based interaction computing entity exchanging the digital asset to the desired asset format, the digital asset-based interaction computing entity instructs the digital asset backing computing entity to release the amount of locked system digital asset.

Step 2 of FIG. 24A may occur before, concurrently, or after obtaining digital assets from the source computing entity (but before exchanging digital assets for desired assets). If step 2 occurs before obtaining digital assets, an acknowledgement (ACK) may be generated. For example, locking the system digital assets implies authorization of the digital asset-based interaction, and the digital asset-based interaction computing entity 16 allows a time period (e.g., up to five minutes) prior to obtaining digital assets from the source computing entity (e.g., the first computing entity has time to add tip, split payment with another user, adjust type of digital asset used, etc.). The destination computing entity is provided a confirmation of this ACK. For example, when the destination computing entity is a POS computing device such as an attended register, this ACK may successfully end the in-person transaction such that a merchant and customer can part ways. However, the destination computing entity receives the payment up to a few minutes later.

When the digital asset backing computing entity 16 locks the system digital assets, a rate quote for the amount of digital assets used by the source computing entity is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 3 where the digital asset-based interaction computing entity 16 connects to the digital asset DLT network 28 associated with the digital assets 34 used by the source computing entity to verify obtaining the digital assets 34. The digital asset DLT network 28 implements a validation procedure that may take minutes to hours of time.

The method continues with FIG. 24B with step 4 where the amount of digital assets is verified. The method continues with step 5 where the digital asset-based interaction computing entity 16 instructs the digital asset backing computing entity 20 to release the amount of system digital assets associated with the digital asset-based interaction (e.g., locked system digital assets 138). The method continues with step 6 where the digital asset backing computing entity 20 releases the locked system digital assets 138.

Alternatively, the method continues with FIG. 24C with alternative step 4 where the amount of digital assets is not verified. For example, if fraudulent activity occurs (e.g., the source computing entity acts maliciously to spend the same funds at two merchants simultaneously, software of the asset management unit is corrupted, etc.) the digital asset-based interaction computing entity consumes at least a portion of the amount of system digital assets associated with the digital asset-based interaction (e.g., locked system digital assets 138). As a specific example, if the source computing entity attempts to double spend a transaction, the verification (e.g., the desired number of confirmations in a Bitcoin blockchain example) will not be received and the digital asset-based interaction computing entity will not be able to verify the amount of the digital asset received by the source computing entity.

The method continues with step 5 where the digital asset-based interaction computing entity 16 instructs the digital asset backing computing entity 20 to consume at least a portion of the amount of system digital assets associated with the digital asset-based interaction (e.g., locked system digital assets 138).

Consuming the amount of system digital asset means that (at step 6) the amount of system digital assets is transferred (e.g., via an on-chain transaction) from an address associated with the transformer pool 26 to an address associated with the digital asset-based interaction computing entity 16. When the amount of system digital assets is more than the amount of the digital asset-based interaction, only a portion of the amount of system digital assets (to cover the digital asset-based interaction) may be consumed while the remainder is unlocked. In another example, regardless of whether the amount of system digital assets is more than the amount of the digital asset-based interaction, the entire amount of the of system digital assets may be consumed.

FIG. 25 is a schematic block diagram of an embodiment of a portion of a digital asset-based interaction system 10 that includes a digital asset backing computing entity 20, one or more staking computing entities 24, transformer pool 26-1 through 26-2, stake pool 140, digital asset distributed ledger technology (DLT) networks 28-1 through 28-2, and a custodial digital asset management unit 142.

The digital asset backing computing entity 20 manages the storage and use of system digital assets (e.g., system cryptocurrency, system tokens, etc.) for collaterally backing digital asset-based interactions and may be a part of or separate from the digital asset-based interaction computing entity 16. The digital asset backing computing entity 20 interacts with the one or more staking computing entities 24. The one or more staking computing entities 24 provide the digital asset backing computing entity 20 with system digital assets (deposits/withdrawals 144) and instructions on how to stake the system digital assets (staking instructions 146).

The one or more staking computing entities 24 may be one or more user computing devices, one or more merchant computing entities, a digital asset management computing entity associated with an asset management unit, one or more computing entities associated with a corporation and/or business, etc. The one or more staking computing entities 24 (e.g., a user computing device, etc.) are associated with the digital asset backing computing entity 20 via an account (e.g., a stake account).

System digital assets are digital assets that serve as collateral to back digital asset-based interactions of the digital asset-based interaction system. The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency. The digital asset backing computing entity 20 also manages information associated with the one or more staking computing entities 24 such as identifying information of the one or more staking computing entities 24, system digital asset balances and availability, rewards calculations, etc.

The digital asset DLT networks 28-1 through 28-2 are digital systems associated with a particular digital asset. A digital asset DLT network includes a plurality of consensus network computing entity nodes operable to implement a validation procedure to verify the authenticity of transactions recorded on a distributed ledger. For example, the validation procedure is a consensus method. Examples of consensus methods include proof-of-work, proof-of-stake, Practical Byzantine Fault Tolerance (PBFT), and Directed Acyclic Graph (DAG). The plurality of consensus computing entity nodes executes the validation procedure to validate and broadcast transactions to the distributed ledger stored by each consensus network computing entity node of the plurality of consensus network computing entity nodes.

For example, the DLT network 28-1 may be the Ethereum network and the particular digital asset it is associated with is Ether. As another example, the DLT network 28-2 may be the Bitcoin network and the particular digital asset it is associated with is Bitcoin.

The custodial asset management unit 142 may be a custodial digital wallet application associated with a digital asset management computing entity that may be specially licensed and insured to hold digital assets (e.g., a digital asset holding and management company, a cryptocurrency holding company, a cryptocurrency holding and exchange company, etc.). The digital asset management computing entity (i.e., “the custodian”) of a custodial digital wallet application holds the private key needed to gain access to digital assets.

In this example, the one or more the staking computing entities 24 provide the digital asset backing computing entity 20 with system digital assets (e.g., deposits/withdrawals 144) and staking instructions 146. The staking instructions 146 include instructions to stake an amount of system digital assets 148-1 to back the digital asset DLT network 28-1 (e.g., the Ethereum network), instructions to stake an amount of system digital assets 148-2 to back the digital asset DLT network 28-2 (e.g., the Bitcoin network), and instructions to stake an amount of system digital assets 148-3 to back a custodial asset management unit 142. The digital asset backing computing entity 20 keeps track of the amounts of system digital assets each staking computing entity 24 of the one or more staking computing entities 24 is contributing/depositing via each staking computing entity's account.

Backing the digital asset DLT networks 28-1 and 28-2 means that a consensus network computing entity node 36-1_1 of the digital asset DLT network 28-1 is backed to ensure transactions are written onto the ledger and a consensus network computing entity node 36-2_1 of the digital asset DLT network 28-2 is backed to ensure transactions are written onto the ledger. The consensus network computing entity nodes 36-1_1 and 36-2_1 may be associated with the digital asset-based interaction computing entity 16. Backing a particular consensus network computing entity node of the digital asset DLT network 28 is necessary for backing digital asset-based interactions involving digital assets stored in a non-custodial asset management unit not associated with the digital asset-based interaction computing entity 16 because the non-custodial asset management unit is interfacing directly with the digital asset DLT network when initiating digital asset-based interactions. When a digital asset-based interaction involves digital assets stored in a custodial asset management unit, the custodial asset management unit (such as custodial asset management unit 142) is backed rather than a particular consensus network computing entity node of the digital asset DLT network because the custodian (e.g., a digital asset management computing entity) interacts with the digital asset DLT network on behalf of the custodial asset management unit.

Based on the staking instructions 146, the digital asset backing computing entity 20 deposits the amount of the system digital assets 148-1 into transformer pool 26-1 where transformer pool 26-1 is associated with the consensus network computing entity node 36-1_1 of the digital asset DLT network 28-1, deposits the amount of the system digital assets 148-2 into transformer pool 26-2 where transformer pool 26-2 is associated with the consensus network computing entity node 36-2_1 of the digital asset DLT network 28-2, and deposits the amount of the system digital assets 148-3 into the stake pool 140 where the stake pool 140 is associated with the custodial asset management unit 142.

The transformer pools 26-1 through 26-2 and the stake pool 140 are smart contracts (e.g., Ethereum smart contracts) that store system digital assets to back digital asset DLT networks 28-1 through 28-2 and the custodial asset management unit 142. For example, the transformer pool 26-1 stores system digital assets 136-1 for backing digital asset DLT network 28-1 digital asset-based interactions (e.g., digital asset-based interactions involving Ether when the digital asset DLT network 28-1 is the Ethereum network), the transformer pool 26-2 stores system digital assets 136-2 for backing digital asset DLT network 28-2 digital asset-based interactions (e.g., digital asset-based interactions involving Bitcoin when the digital asset DLT network 28-2 is the Bitcoin network), and the stake pool 140 stores system digital assets 136-3 for custodial asset management unit 142 digital asset-based interactions.

With digital asset DLT networks backed by system digital assets, users (e.g., source computing entities) can provide digital assets associated with those backed digital asset DLT networks for digital asset-based interactions from any digital wallet application (e.g., asset management unit) of their choosing. In other words, a user does not need to be associated with the digital asset-based interaction system (e.g., use an asset management unit that is staked and therefore associated with the digital asset-based interaction computing entity) to partake in digital asset-based interactions facilitated by the digital asset-based interaction system.

FIG. 26 is schematic block diagram of an embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, at least one transformer pool 26, and at least one digital asset distributed ledger technology (DLT) network 28.

The digital asset-based interaction system 10 of FIG. 26 operates similarly to the digital asset-based interaction system 10 of FIG. 1 except that the digital asset-based interaction computing entity 16 of FIG. 26 is shown including a digital asset-based interaction authorization module 150.

By staking the digital asset DLT network 28 associated with the digital assets 34 to allow source computing entities to use any asset management unit of their choosing for providing digital assets 34, the asset management units and source computing entities may not be associated with the digital asset-based interaction system 10 and could introduce fraud, risk, and errors to the system. To mitigate these issues, upon obtaining digital asset-based interaction information and/or digital assets for a digital asset-based interaction, the digital asset-based interaction authorization module 150 is operable to authorize the digital asset-based interaction by performing an authorization process. The authorization process involves comparing characteristics of the digital asset-based interaction with system authorization parameters related to the digital asset-based interaction to detect errors and/or fraudulent activity associated with the digital asset-based interaction.

The authorization process may occur at different times in the digital asset-based interaction (before or after the system digital assets are locked but before the digital assets are exchanged for desired assets). For example, the authorization process occurs when the digital assets are received by the digital asset-based interaction computing entity 16 and the system digital assets are locked by the digital asset backing computing entity 20 (as discussed with reference to FIGS. 21 and 23). As another example, the authorization process occurs when the digital assets are received by the digital asset-based interaction computing entity 16 and the system digital assets are not locked yet by the digital asset backing computing entity 20 (as discussed with reference to FIG. 22).

The characteristics of the digital asset-based interaction include the digital asset-based interaction information (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity 16. The transaction data will be discussed in more detail with reference to FIG. 28.

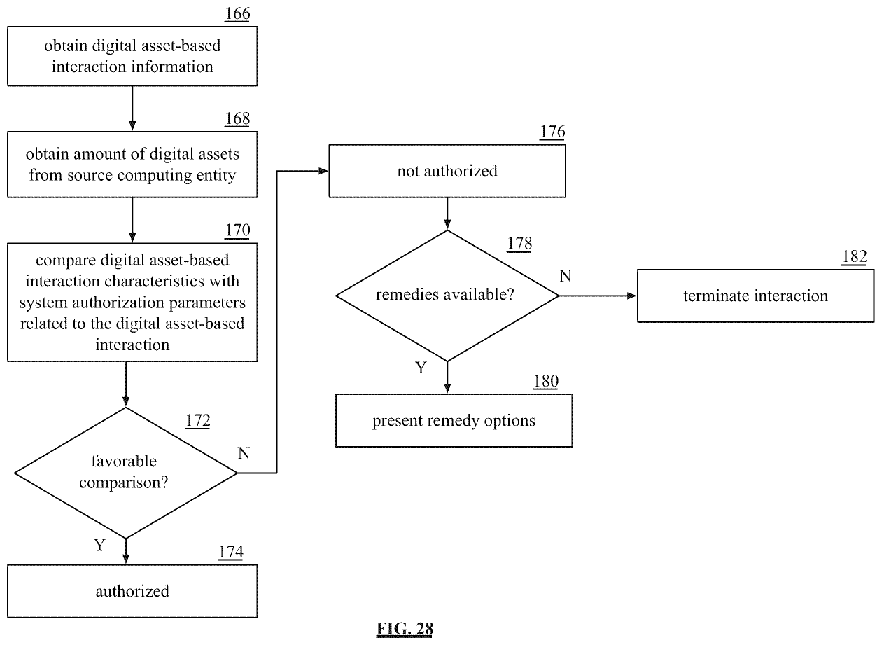

The system authorization parameters include system information (e.g., digital asset-based interaction historical data, tolerance thresholds, user information, etc.) and digital asset DLT network information. The digital asset DLT network information may include any information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus method such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc. The system authorization parameters will be discussed in more detail with reference to FIG. 27.

FIG. 27 is a schematic block diagram of an embodiment of a digital asset-based interaction computing entity 16 that includes a digital asset-based interaction authorization module 150. The digital asset-based interaction authorization module 150 includes a system authorization parameter module 152, a digital asset-based interaction characteristics module 154, and a comparison module 156.

In this example, a digital asset-based interaction has been initiated (e.g., the digital asset-based interaction computing entity 16 has obtained the digital asset-based interaction information 164) and the digital asset-based interaction computing entity 16 has obtained an amount of digital assets 34 from a source computing entity for the digital asset-based interaction. To mitigate potential errors and risk, upon obtaining digital asset-based interaction information and/or digital assets for a digital asset-based interaction, the digital asset-based interaction authorization module 150 is operable to authorize the digital asset-based interaction.

The system authorization parameter module 152 stores, gathers, organizes, determines, etc., system authorization parameters 158. The system authorization parameters 158 include system information and digital asset distributed ledger technology (DLT) network information. The system information includes historical data, user information, and/or system tolerance thresholds. The digital asset DLT network information includes information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus algorithm such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc.

The system authorization parameters 158 may be generated based on a digital asset-based interaction to digital asset-based interaction basis and/or pre-generated. For example, for a digital asset-based interaction involving a digital asset A, the system authorization parameter module 152 may connect to a digital asset A DLT network to obtain digital asset A DLT network information as system authorization parameters. In another example, the system authorization parameter module 152 may periodically connect to digital asset A DLT network and store digital asset A DLT network information as system authorization parameters 158.

As another example, the system authorization parameter module 152 may store historical data in a lookup table and upon a new digital asset-based interaction, will look up the appropriate data (e.g., historical data related to a particular source computing entity, etc.) from the lookup table to include as system authorization parameters 158.

The digital asset-based interaction characteristics module 154 stores, gathers, organizes, determines, etc., characteristics of an incoming digital asset-based interaction (e.g., digital asset-based interaction characteristics 160). The digital asset-based interaction characteristics 154 include the digital asset-based interaction information 164 (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity 16 (e.g., the amount of digital assets 34).

The information contained in the transaction data depends on the type of digital asset and digital asset DLT network involved. Transaction data will be discussed in more detail with reference to FIG. 28. After a digital asset-based interaction authorization, the digital asset-based interaction characteristics module 154 may transfer digital asset-based interaction characteristics 160 to the system authorization parameter module 158 to be stored as historical data.

The comparison module 156 compares system authorization parameters 158 provided by the system authorization parameter module 152 with the digital asset-based interaction characteristics 160 provided by the digital asset-based interaction characteristics module 154 to determine a result 162. When the system authorization parameters 158 compare favorably to the digital asset-based interaction characteristics 160, the result 162 is an authorized result. The system authorization parameters 158 may compare favorably to the digital asset-based interaction characteristics 160 when they are within a system tolerance threshold, when they are substantially equal, etc.

When the system authorization parameters 158 do not compare favorably to the digital asset-based interaction characteristics 160, the result 162 is a non-authorized result. The system authorization parameters 158 may not compare favorably to the digital asset-based interaction characteristics 160 when they are not within a system tolerance threshold, when they are not substantially equal, etc. When the result 162 is a non-authorized result, the digital asset-based interaction authorization module 150 may present remedy options to the source computing entity to correct a particular issue and/or retry the digital asset-based interaction. Alternatively, when the result 162 is a non-authorized result, the digital asset-based interaction authorization module 150 may terminate the digital asset-based interaction.

FIG. 28 is a flowchart of an example of a method of a digital asset-based interaction authorization process executable by a digital asset-based interaction authorization module of a digital asset-based interaction computing entity of a digital asset-based interaction system.

The method begins with step 166 where the digital asset-based interaction computing entity obtains digital asset-based interaction information from one or more of a source computing entity and a destination computing entity. The digital asset-based interaction involves the source computing entity providing digital assets and the second computing entity accepting desired assets. The digital asset-based interaction information includes source computing entity information (e.g., a source computing entity identifier (ID)), destination computing entity information (e.g., a destination computing entity identifier (ID)), item(s) involved in the digital asset-based interaction, the amount of the digital asset-based interaction, digital asset-based interaction metadata, etc.

The method continues with step 168 where the digital asset-based interaction computing entity obtains an amount of digital assets from the source computing entity. Obtaining the amount of the digital assets is a transaction added to a digital asset distributed ledger technology (DLT) network associated with the digital assets. The method continues with step 170 where the digital asset-based interaction authorization module of the digital asset-based interaction computing entity compares digital asset-based interaction characteristics with system authorization parameters related to the digital asset-based interaction.

The digital asset-based interaction characteristics include the digital asset-based interaction information (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity. The information contained in the transaction data depends on the type of digital asset and digital asset DLT network involved. For example, in an Ethereum transaction, transaction data includes the recipient (e.g., an address), a signature of the sender, a nonce, a value (e.g., the amount of the digital assets being sent), data, a gas limit, a max priority fee per gas, and a max fee per gas. The transaction data typically includes at least a signature (signed with a private key), an output (e.g., a destination for the funds), an amount (e.g., the amount involved in the transaction), and a transaction fee.

The system authorization parameters include system information and digital asset DLT network information. The system information includes historical data, user information, and/or system tolerance thresholds. The historical data may include past digital asset-based interaction information such as the information pertaining to the parties involved (e.g., source computing entity identifiers (IDs), destination computing entity identifiers (IDs), merchant information, etc.), digital asset-based interaction amounts, whether or not a digital asset-based interaction was successful, etc., as well as historical authorization information such as a list of users associated with unauthorized digital asset-based interactions and/or suspicious activity.

Suspicious activity could include errors (e.g., the amount of digital assets sent is less than or more than the amount owed for the digital asset-based interaction), transaction fee issues (e.g., a transaction fee is too low which could be an indication of potential fraud), repeated digital asset-based interaction terminations (e.g., the user has a history of initiating and canceling digital asset-based interactions), etc.

The system tolerance thresholds include ranges of tolerance to use in comparison situations. The system tolerance thresholds may be stored/generated as system information and provided to the comparison module to use in comparisons. For example, certain digital asset-based interaction characteristics may be compared with each other in accordance with a system tolerance threshold. For example, a system tolerance threshold for the amount of the digital asset-based interaction may be 0%. For example, if the source computing entity sends an amount of digital assets that is not exactly equal to the amount of the digital assets in the digital asset-based interaction as identified in the digital asset-based interaction information (e.g., it is too low or too high), the digital asset-based interaction may not be authorized.

User information includes identifying information of parties involved in past and/or current digital asset-based interactions as well as any personal information such as email address, username, password, physical address, loyalty information, etc. Historical user information may be stored with the historical data. In an example, a source computing entity may provide a username and password as identifying information while initiating a digital asset-based interaction. This username and password (e.g., digital asset-based interaction characteristics) will be cross referenced with username and password combinations stored in the user information (e.g., system authorization parameters) for errors and/or issues (e.g., the source computing entity may enter the wrong password associated with its source identifier (ID)).

The digital asset DLT network information includes any information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus algorithm such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc. The system authorization parameters may be generated based on a digital asset-based interaction to digital asset-based interaction basis and/or pre-generated.

The method continues with step 172 where the digital asset-based interaction authorization module determines whether the comparison is favorable. For example, a favorable comparison may occur when a transaction fee (e.g., a digital asset-based interaction characteristic) is greater than or equal to a minimum transaction fee value (e.g., a system authorization parameter). When the comparison is favorable, the method continues with step 174 where the digital asset-based interaction is authorized. When the comparison is not favorable, the method continues with step 176 where the digital asset-based interaction is not authorized. For example, an unfavorable comparison may occur when a transaction fee (e.g., a digital asset-based interaction characteristic) is lower than a minimum transaction fee value (e.g., a system authorization parameter).

When the digital asset-based interaction is not authorized at step 176, the method continues with step 178 where the digital asset-based interaction authorization module determines whether there are remedies available. For example, if the digital asset-based interaction was not authorized because the amount of digital assets sent was too high, the source computing entity may be given a chance to correct the amount. As another example, if the digital asset-based interaction was not authorized because the transaction fee for the amount of digital assets sent was too low, the source computing entity may be given a chance to increase the fee.

When there are remedies available at step 178, the method continues with step 180 where the digital asset-based interaction authorization module presents the remedy options to the source computing entity. For example, when the source computing entity scans a scannable code presented by the destination computing entity to forward the digital assets to the digital asset-based interaction computing entity and the digital asset-based interaction is not authorized, the digital asset-based interaction authorization module may send a notification to the destination computing entity that the digital asset-based interaction was not authorized and to have the source computing entity scan the code again (or scan a new code) to correct any errors or issues.

In another example, a remedy notification may be pushed directly to the source computing entity when scanning the code establishes a communication between the source computing entity and the digital asset-based interaction computing entity or when the source computing entity accesses the destination computing entity via an application installed on the source computing entity.

When the are no remedies available at step 178, the method continues with step 182 where the digital asset-based interaction authorization module terminates the digital asset-based interaction. For example, when the digital asset-based interaction authorization module identifies the source computing entity as a previously bad actor, there may be no remedies available, and the digital asset-based interaction may be terminated. When the digital asset-based interaction is terminated, the digital asset-based interaction authorization module may send a termination notification to one or more of the source computing entity and the destination computing entity.

The digital asset-based interaction authorization process and the digital asset-based interaction system are discussed in more detail with reference to co-pending provisional patent application No. 63/382,706, entitled, “DIGITAL ASSET-BASED INTERACTION SYSTEM WITH ONE OR MORE STAKED DISTRIBUTED LEDGER TECHNOLOGY (DLT) NETWORKS,” filed Nov. 7, 2022.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
accessing, by a source computing entity, a destination computing entity-presented user interface to initiate a digital asset-based interaction, wherein the digital asset-based interaction involves a digital asset-based interaction computing entity of a digital asset-based interaction system pulling digital assets from the source computing entity and a destination computing entity of the digital asset-based interaction system accepting desired assets;
providing, by the source computing entity, a set of source inputs to the digital asset-based interaction computing entity, via the destination computing entity-presented user interface, wherein the digital asset-based interaction computing entity is operable to execute the digital asset-based interaction using a real-time process to provide the desired assets to the destination computing entity and a nonreal-time process to verify the digital assets pulled from the source computing entity;
generating, by the digital asset-based interaction computing entity, a digital asset-based interaction request having instructions for pulling the digital assets based on a set of digital asset-based interaction inputs, wherein the set of digital asset-based interaction inputs includes at least some of the set of source inputs;
locking, by the digital asset-based interaction computing entity, an amount of system digital assets as collateral for the digital assets, wherein the amount of system digital assets is stored in a transformer pool associated with a digital asset distributed ledger technology (DLT) network of the digital assets; and
sending, by the digital asset-based interaction computing entity, the destination computing entity a notification of a successful digital asset-based interaction based on the generation of the digital asset-based interaction request.

2. The method of claim 1, wherein the destination computing entity-presented user interface is hosted by the digital asset-based interaction computing entity on the destination computing entity.

3. The method of claim 1, wherein the destination computing entity-presented user interface is integrated into the destination computing entity.

4. The method of claim 1, wherein the accessing the destination computing entity-presented user interface comprises:
obtaining, by the source computing entity, a link from the destination computing entity via an interface, wherein the link provides the source computing entity access to the destination computing entity-presented user interface.

5. The method of claim 4, wherein the link is a repeatable link usable by a plurality of source computing entities.

6. The method of claim 1, wherein the accessing the destination computing entity-presented user interface comprises:
accessing, by the source computing entity, the destination computing entity-presented user interface via a browser application of the source computing entity.

7. The method of claim 1, wherein the accessing the destination computing entity-presented user interface comprises:
accessing, by the source computing entity, the destination computing entity-presented user interface via a mobile application of the source computing entity associated with the destination computing entity.

8. The method of claim 1, wherein the accessing the destination computing entity-presented user interface comprises:
connecting, by the source computing entity, via an interface, to the destination computing entity, wherein the destination computing entity provides the destination computing entity-presented user interface via the interface.

9. The method of claim 1, wherein the set of digital asset-based interaction inputs includes a source identifier (ID) associated with the source computing entity, a digital asset-based interaction intention, and an amount of the digital asset-based interaction.

10. The method of claim 1, wherein the generating the digital asset-based interaction request comprises:
interpreting, by the digital asset-based interaction computing entity, the set of digital asset-based interaction inputs to produce an address associated with the source computing entity for accessing the digital assets.

11. The method of claim 1, wherein the real-time process comprises:
obtaining, by the digital asset-based interaction computing entity, an amount of the digital assets from an address associated with the source computing entity;
exchanging, by the digital asset-based interaction computing entity, the amount of the digital assets to a substantially equivalent amount of the desired assets; and
providing, by the digital asset-based interaction computing entity, the amount of the desired assets to the destination computing entity.

12. The method of claim 11, wherein the nonreal-time process comprises:
connecting, by the digital asset-based interaction computing entity, to the digital asset DLT network to verify the obtaining the amount of the digital assets; and
when the amount of the digital assets is verified:
releasing, by the digital asset-based interaction computing entity, the amount of system digital assets; and
when the amount of the digital assets is not verified:
consuming, by the digital asset-based interaction computing entity, at least a portion of the amount of system digital assets.

13. A computer readable memory comprises:
a first memory element that stores operational instructions that, when executed by a source computing entity, causes the source computing entity to:
access a destination computing entity-presented user interface to initiate a digital asset-based interaction, wherein the digital asset-based interaction involves a digital asset-based interaction computing entity of a digital asset-based interaction system pulling digital assets from the source computing entity and a destination computing entity of the digital asset-based interaction system accepting desired assets; and
provide a set of source inputs to the digital asset-based interaction computing entity, via the destination computing entity-presented user interface, wherein the digital asset-based interaction computing entity is operable to execute the digital asset-based interaction using a real-time process to provide the desired assets to the destination computing entity and a nonreal-time process to verify the digital assets pulled from the source computing entity; and
a second memory element that stores operational instructions that, when executed by the digital asset-based interaction computing entity, causes the digital asset-based interaction computing entity to:
generate a digital asset-based interaction request having instructions for pulling the digital assets based on a set of digital asset-based interaction inputs, wherein the set of digital asset-based interaction inputs includes at least some of the set of source inputs;
lock an amount of system digital assets as collateral for the digital assets, wherein the amount of system digital assets is stored in a transformer pool associated with a digital asset distributed ledger technology (DLT) network of the digital assets; and
send the destination computing entity a notification of a successful digital asset-based interaction based on the generation of the digital asset-based interaction request.

14. The computer readable memory of claim 13, wherein the destination computing entity-presented user interface is hosted by the digital asset-based interaction computing entity on the destination computing entity.

15. The computer readable memory of claim 13, wherein the destination computing entity-presented user interface is integrated into the destination computing entity.

16. The computer readable memory of claim 13, wherein the first memory element further stores operational instructions that, when executed by the source computing entity, causes the source computing entity to access the destination computing entity-presented user interface by:
obtaining a link from the destination computing entity via an interface, wherein the link provides the source computing entity access to the destination computing entity-presented user interface.

17. The computer readable memory of claim 16, wherein the link is a repeatable link usable by a plurality of source computing entities.

18. The computer readable memory of claim 13, wherein the first memory element further stores operational instructions that, when executed by the source computing entity, causes the source computing entity to access the destination computing entity-presented user interface by:
accessing the destination computing entity-presented user interface via a browser application of the source computing entity.

19. The computer readable memory of claim 13, wherein the first memory element further stores operational instructions that, when executed by the source computing entity, causes the source computing entity to access the destination computing entity-presented user interface by:
accessing the destination computing entity-presented user interface via a mobile application of the source computing entity associated with the destination computing entity.

20. The computer readable memory of claim 13, wherein the first memory element further stores operational instructions that, when executed by the source computing entity, causes the source computing entity to access the destination computing entity-presented user interface by:
connecting via an interface to the destination computing entity, wherein the destination computing entity provides the destination computing entity-presented user interface via the interface.

21. The computer readable memory of claim 13, wherein the set of digital asset-based interaction inputs includes a source identifier (ID) associated with the source computing entity, a digital asset-based interaction intention, and an amount of the digital asset-based interaction.

22. The computer readable memory of claim 13, wherein the second memory element further stores operational instructions that, when executed by the digital asset-based interaction computing entity, causes the digital asset-based interaction computing entity to generate the digital asset-based interaction request by:
interpreting the set of digital asset-based interaction inputs to produce an address associated with the source computing entity for accessing the digital assets.

23. The computer readable memory of claim 13, wherein the second memory element further stores operational instructions that, when executed by the digital asset-based interaction computing entity, causes the digital asset-based interaction computing entity to execute the real-time process by:
obtaining an amount of the digital assets from an address associated with the source computing entity;
exchanging the amount of the digital assets to a substantially equivalent amount of the desired assets; and
providing the amount of the desired assets to the destination computing entity.

24. The computer readable memory of claim 23, wherein the second memory element further stores operational instructions that, when executed by the digital asset-based interaction computing entity, causes the digital asset-based interaction computing entity to execute the nonreal-time process by:
connecting to the digital asset DLT network to verify the obtaining the amount of the digital assets; and
when the amount of the digital assets is verified:
releasing the amount of system digital assets; and
when the amount of the digital assets is not verified:
consuming at least a portion of the amount of system digital assets.
